(19) United States
(12) Patent Application Publication
(10) Pub. No.: US 2022/0391887 A1
(43) Pub. Date: Dec. 8, 2022

(54) Systems and Methods for Maintenance of NFT Assets

(71) Applicant: Artema Labs, Inc, Los Angeles, CA (US)

(72) Inventors: Bjorn Markus Jakobsson, Portola Valley, CA (US); Stephen C. Gerber, Austin, TX (US); Guy A. Stewart, Olympia, WA (US)

(73) Assignee: Artema Labs, Inc, Los Angeles, CA (US)

(21) Appl. No.: 17/806,065

(22) Filed: Jun. 8, 2022

Related U.S. Application Data
(60) Provisional application No. 63/208,366, filed on Jun. 8, 2021.

(51) Int. Cl. G06Q 20/36; G06Q 20/06; H04L 9/32; H04L 9/08; G06Q 20/38

(52) U.S. Cl. CPC G06Q 20/3678; G06Q 20/3674; G06Q 20/065; H04L 9/3239; H04L 9/0825; G06Q 20/3829; G06Q 20/3827; G06Q 20/38215; G06Q 2220/16

(57) ABSTRACT

Systems and devices to account for automated conditional payments from within an NFT platform to maintain resources including (but not limited to) computer systems and/or sources of data relied upon by the platform are disclosed. One embodiment is a system that includes a paying module and a bounty hunting module. The paying module generates an agreement, the agreement including terms of the performance of service. The bounty hunting module performs steps for ensuring the service is performed. The bounty hunting module obtains publicly verifiable evidence related to the performance of service. The bounty hunting module generates an assertion including the publicly verifiable evidence and a reference to a public key. The bounty hunting module posts the assertion to an immutable ledger entry. The bounty hunting module obtains payment based on validity of the assertion, wherein the assertion is valid when the assertion is determined to be true.

### CROSS-REFERENCE TO RELATED APPLICATIONS

The current application claims the benefit of and priority under 35 U.S.C. § 119(e) to U.S. Provisional Patent Application No. 63/208,366 entitled “Perpetual NFT Assets,” filed Jun. 8, 2021. The disclosure of U.S. Provisional Patent Application No. 63/208,366 is hereby incorporated by reference in its entirety for all purposes.

### FIELD OF THE INVENTION

The present invention generally relates to systems and methods directed to the minting of non-fungible tokens and maintenance of newly-created non-fungible tokens. The present invention additionally relates to systems and methods directed to reporting activity and the provision of services related to automated conditional payments around non-fungible token transactions within media platforms.

### BACKGROUND

In applications to online commerce, there are currently significant inefficiencies related to the management of information and the automatic generation of and management of interlinked digital representations of state. This can affect information including identity information, ownership, access and usage rights, and predicates about people and organizations.

### SUMMARY OF THE INVENTION

Systems and devices to account for automated conditional payments from within an NFT platform to maintain resources including (but not limited to) computer systems and/or sources of data relied upon by the platform are illustrated. One embodiment is a system that includes a paying module and a bounty hunting module. The paying module generates an agreement with a service provider, the agreement including terms of the performance of service. The bounty hunting module performs steps for ensuring the service is performed. The bounty hunting module reviews the agreement between the service provider and the paying module. The bounty hunting module obtaining publicly verifiable evidence related to the performance of service. The bounty hunting module generates an assertion including the publicly verifiable evidence and a reference to a public key. The bounty hunting module posts the assertion to an immutable ledger entry. The bounty hunting module obtains payment based on validity of the assertion, wherein the assertion is valid when the assertion is determined to be true.

In a further embodiment, posting the assertion to an immutable ledger entry includes posting a commitment to the assertion to a first immutable ledger entry, where the commitment includes a hash of the publicly verifiable evidence, the public key, and a random string. Posting the assertion to an immutable ledger entry also includes posting a decommitment to the assertion to a second immutable ledger entry, where the decommitment includes the publicly verifiable evidence, the public key, and the random string. In the further embodiment, the second immutable ledger entry is generated subsequently to the first immutable ledger entry.

In still another embodiment, the hash used in the commitment utilizes a SHA-256 hash function.

In still another embodiment, posting the assertion to an immutable ledger entry includes using a verifiable delay function on the assertion, where the verifiable delay function utilizes a Proof of Work mechanism.

In still another embodiment, the system also includes one or more miners. At least one miner assess the validity of the assertion posted by the bounty hunting module. In assessing the validity of the assertion, the at least one miner accesses the immutable ledger entry. The at least one miner reviews the assertion through the publicly verifiable evidence related to the performance of the service. The at least one miner evaluates the validity of the publicly verifiable evidence, the publicly verifiable evidence being data, relevant to the performance of the service, that is gathered through communication over a network. When the publicly verifiable evidence is evaluated as true, the at least one miner including the assertion in a block; generates a challenge based, at least in part, on the block; generates a proof based, at least in part, on the challenge; and publishes the challenge and the proof on the immutable ledger entry.

In a further embodiment, the system also includes a quorum of verifiers, each of which further assesses the validity of the assertion. The verifiers access the block, the challenge, and the proof through the immutable ledger entry. The verifiers review the assertion including the publicly verifiable evidence related to the performance of the service. The verifiers evaluate the validity of the publicly verifiable evidence in the assertion. When a verifier evaluates that the publicly verifiable evidence is false, they generate a new challenge based on a new immutable ledger entry, where the new immutable ledger entry omits the assertion. When a verifier evaluates that the publicly verifiable evidence is true, they transmit assent to including the block on a ledger.

In yet another embodiment, the service provider agrees to provide access control to NFTs for the paying module. The access control is facilitation of NFT access by members of the public where different classifications of token indicate different rights of access to the service provider.

In a further embodiment, bounty hunting modules collect publicly verifiable evidence of failure to perform the service. The bounty hunting modules attempt to obtain access to the NFTs without meeting particular rights of access. When the bounty hunting modules are allowed access by the service provider; they note the failure to facilitate token access as the publicly verifiable evidence of failure to perform the service.

In yet another embodiment, the paying module generates the agreement with a virtual service provider. A second service provider is a physical service provider that provides resources to the virtual service provider. The virtual service provider shares the resources provided by the virtual service provider by performing a hosting task.

In a further embodiment, the virtual service provider is a non-fungible token.

In still yet another embodiment, in obtaining payment the bounty hunting module conveys a message to the paying module where the message comprises a coin reference, an amount indicator, and the public key; the reference indicates a financial entity from which funds are to be transferred; and the amount indicator indicates the amount of and type of currency associated with the transfer. The bounty hunting module receives the message after the message has been digitally signed by the paying module where the message is digitally signed using a secret key corresponding to the public key, and the digitally signed message indicates value associated with the transfer.

In still yet another embodiment, each bounty hunting module is associated with a reputation score. Invalid assertions decrease the reputation score and valid assertions increase the reputation score. Payment obtained by a bounty hunting module is positively correlated with the bounty hunting module's reputation score.

One embodiment includes a device configured to interact with a composite NFT. The device includes a network interface, a memory, and a processor. The processor is configured to access bytecode stored within an immutable ledger, where the bytecode encodes a composite non-fungible token (NFT) and includes references to bytecode stored within the immutable ledger encoding two or more additional NFTs. The processor executes the bytecode encoding the composite NFT within a virtual machine. To execute the bytecode, the processors selects a content component from each of the two or more additional NFTs. The content components from each of the two or more additional NFTs are accessed by causing execution of the bytecode stored within the immutable ledger that encodes the two or more additional NFTs. The processor provides access to the selected content components for display, wherein each of the selected content components is selected from a group consisting of audio components, visual components, and audiovisual components.

One embodiment includes a device configured to perform transactions involving annuity coins, including a network interface; memory; and a processor. The processor is configured to receive a digitally signed message, where the digitally signed message is signed using a secret key associated with a public key that identifies an account of an intended recipient of funds. The processor accesses bytecode stored within an immutable ledger, where the bytecode encodes an annuity coin that includes the public key associated with the secret key and a validity indicator. The processor executes the bytecode encoding the annuity coin within a virtual machine. Executing the bytecode verifies the validity indicator and broadcasts a transaction transferring at least some of the funds to the account of the intended recipient of the funds identified by the public key.

In a further embodiment, the processor executing the bytecode determines a trigger for transferring funds at least some of the funds to the account of the intended recipient of the funds identified by the public key based upon verifying an occurrence of a publicly verifiable event.

In a still further embodiment, the validity indicator is a challenge and a proof corresponding to the annuity coin. The validity indicator is valid when the proof is a valid solution to the challenge.

In another embodiment, wherein the validity indicator includes a reference to a contract between a payer and the recipient of the funds; and a reference to evidence of contract performance.

In yet another embodiment, the validity indicator comprises a digitally signed message from a paying module; and a reference to another coin.

One embodiment includes a machine readable medium containing bytecode stored within an immutable ledger, where the bytecode encodes an annuity coin. The annuity coin that is encoded includes a validity indicator, wherein the validity indicator confirms existence of funds backing the annuity coin; and a public key that identifies an account of an intended recipient of the funds. The machine readable medium's execution of the bytecode causes verification of a digitally signed message, where the digitally signed message is signed using a secret key associated with the public key; and broadcast of a transaction transferring at least some of the funds to the account of the intended recipient of the funds identified by the public key.

In a further embodiment, a trigger for transferring value to the annuity coin is tied to an occurrence of a publicly verifiable event.

In a still further embodiment, the validity indicator is a challenge and a proof corresponding to the annuity coin. The validity indicator is valid when the proof is a valid solution to the challenge.

In another embodiment, wherein the validity indicator includes a reference to a contract between a payer and the recipient of the funds; and a reference to evidence of contract performance.

In yet another embodiment, the validity indicator comprises a digitally signed message from a paying module; and a reference to another coin.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 illustrates a payment system of operation in accordance with a number of embodiments of the invention.

FIG. 19 illustrates a service provision contract in accordance with various embodiments of the invention.

FIG. 20 illustrates a ledger record utilized in payment system in accordance with some embodiments of the invention.

FIG. 21 illustrates a setting in which multiple service providers collaborate to provide a service, in accordance with a number of embodiments of the invention.

FIG. 22A is a conceptual illustration of a contract and its facilitation of rewards in accordance with a number of embodiments of the invention.

FIG. 22B illustrates a digitally signed message in accordance with a number of embodiments of the invention.

FIG. 23 illustrates an example assertion in accordance with many embodiments of the invention.

FIG. 24 illustrates an assertion posted on a ledger record in accordance with some embodiments of the invention.

FIG. 25 illustrates a coin configuration in accordance with many embodiments of the invention.

### DETAILED DESCRIPTION

NFT platforms in accordance with many embodiments of the invention may implement systems directed to providing automated conditional payments from within an NFT platform. Automated conditional payments can be conditional on various factors, such as (but not limited to) the provision of services, the occurrence of events, and/or the passage of time. In many embodiments, NFT platforms can assist with the provision of automated conditional payments in various ways, such as (but not limited to) monitoring the provision of services, setting prices for services, and/or executing payments for provided services.

In a variety of embodiments, NFT platforms can provide automated conditional payments using various mechanisms, such as (but not limited to) smart contracts, bounties, and/or data commitments. Such mechanisms can be used to provide payments, enforce and/or validate conditions, etc. For example, data commitments in accordance with certain embodiments of the invention associate a service or agreement with a particular set of data. In a variety of embodiments, data commitments can be used to validate that data provided by a service provider matches the contracted-for data (e.g., NFT data) specified by an agreement.

While NFTs are typically written to immutable ledgers, data (e.g. images, audio and/or video content) referenced by the NFTs are often stored on separate server systems. In some instances, maintenance of the server systems on which the data resides lapses. In these circumstances, the bytecode of the NFT persists in the absence of data referenced by the NFT, which prevents the bytecode from executing correctly. In many embodiments, periodic payments can be made conditional upon the provision of services related to NFT maintenance within an NFT platform. In this way, owners of NFTs can incentivize the maintenance of the data the underlying NFTs. NFT maintenance may include various services, such as (but not limited to), NFT off-blockchain storage, hosting, audits, oversight, annuities, query services, resource request routing, and/or access control. Conditions in accordance with many embodiments of the invention may include the occurrence of outside events (e.g., stock market performance, graduation, etc.) and/or the passage of time.

Services in accordance with several embodiments of the invention can be provided by service providers. Service providers in accordance with a variety of embodiments of the invention may include contracted (e.g., with an established external agreement) and/or uncontracted. In order to monitor the performance of services by service providers, NFT platforms in accordance with a number of embodiments of the invention can provide for verification of the provision of a service. Verification of services in accordance with a variety of embodiments of the invention can utilize bounty hunters and/or other verification services. In some embodiments, various methods for monitoring and/or assigning reputation scores to bounty hunters, verifying assertions made by bounty hunters, and/or resolving race conditions can be used to monitor the provision of services. Resolving race conditions in accordance with many embodiments of the invention can utilize various methods, such as (but not limited to) commitment/decommitment schemes, verifiable delay functions (VDFs), and/or digital signatures.

NFT platforms in accordance with various embodiments of the invention can set prices and/or execute payments for services. In a number of embodiments, automated conditional payments can be determined based upon fixed pricing, market prices, perpetual auctions, etc. Pricing in accordance with certain embodiments of the invention can be dynamically determined based upon various factors, such as (but not limited to) a quality of service provided, a number of service providers providing the service, a bidding process, assertions from bounty hunters, etc. In several embodiments, prices for automated conditional payments can be set in terms of other services (e.g., advertising, as a virtual service provider). Examples of various automated conditional payments in accordance with a number of embodiments of the invention are described in greater detail below.

As can readily be appreciated, the various automated conditional payment and verification systems described herein are not limited to use within rich media platforms and can deployed in a variety of applications including (but not limited to) applications involving various ledgers and/or blockchains. Accordingly, the description of rich media platforms or NFT platforms that follow and the manner in which systems and processes are described in the context of rich media platforms should be understood as illustrative and not limiting.

### Blockchain-Based Non-Fungible Token Platforms

Systems and methods for implementing blockchain-based Non-Fungible Token (NFT) platforms that provide automated conditional payments in NFT data storage configurations in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

In a number of embodiments, NFT platforms can provide novel NFT types with various applications. For example, NFTs minted using NFT platforms in accordance with various embodiments of the invention can have multifunctional programmable use cases including rewards, private access to premium content and experiences, as discounts toward the purchase of goods, among many other value-added use cases.

NFTs of different types in accordance with some embodiments of the invention may include different attributes that define their unique properties. Attributes in accordance with several embodiments of the invention can include (but are not limited to) the ability to create another NFT, the ability to operate as a unique identifier, the ability to transfer access rights from one NFT to another, etc. NFTs of different types may emphasize different attributes. In a number of embodiments, NFTs can be of various types and used for various applications, including (but not limited to) NFTs as identifying entities, NFTs output by other NFTs, NFTs as content creation assets, and NFTs as evaluating entities. NFTs can be interpreted differently by various platforms in order to create platform-specific user experiences. Metadata associated with an NFT may also include digital media assets such as (but not limited to) images, videos about the specific NFT, and/or the context in which it was created (studio, film, band, company song etc.).

NFT platforms in accordance with several embodiments of the invention can provide for the management and storage of NFTs and their associated data with NFT storage and/or secure media wallet applications. In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, NFT platforms can include media wallet applications that enable users to securely store NFTs and/or other tokens on their devices. Media wallet applications in accordance with a variety of embodiments of the invention can provide novel user interfaces for consuming content (e.g., watching video content, listening to audio content, putting NFTs up for sale, purchasing NFTs, etc.).

Furthermore, media wallet applications (also referred to as “digital wallets”) can enable users to obtain NFTs that prove purchase of rights to access a particular piece of media content on one platform and use the NFT to gain access to the purchased content on another platform. Consumption of such content may be governed by classifications of accessed content through visual user interface systems of media wallet applications in accordance with a variety of embodiments of the invention.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

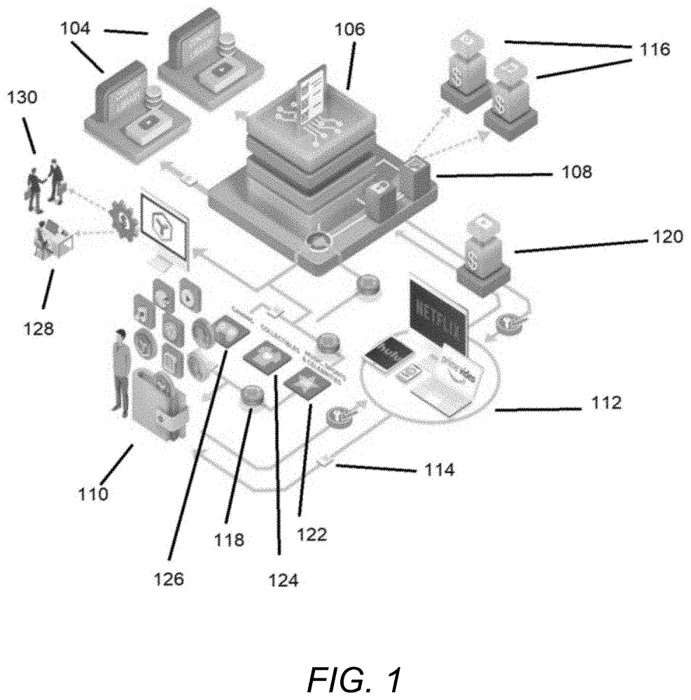

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

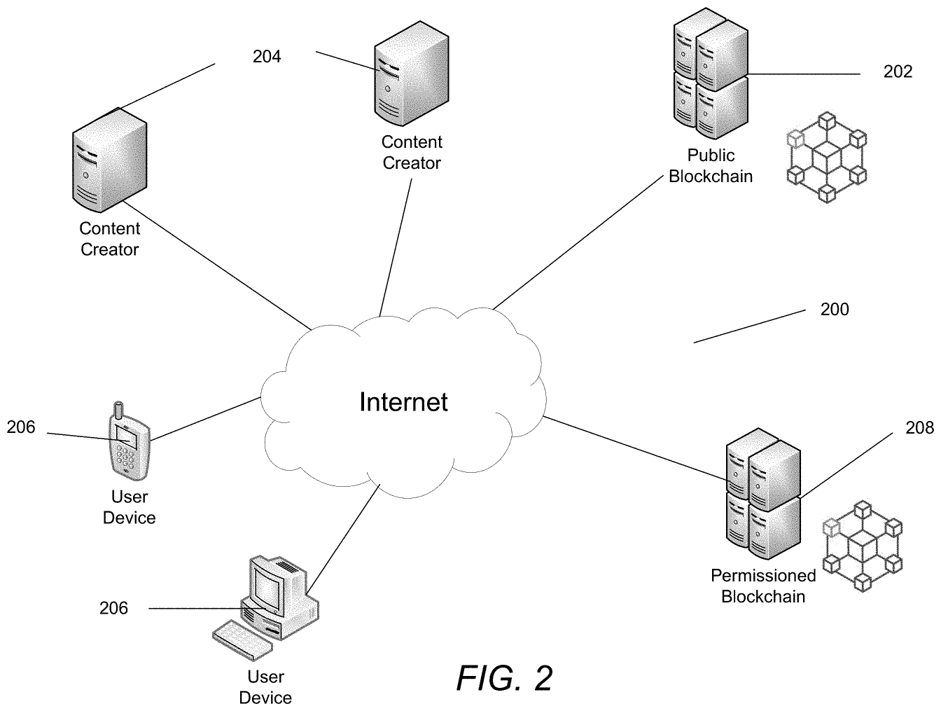

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity. and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

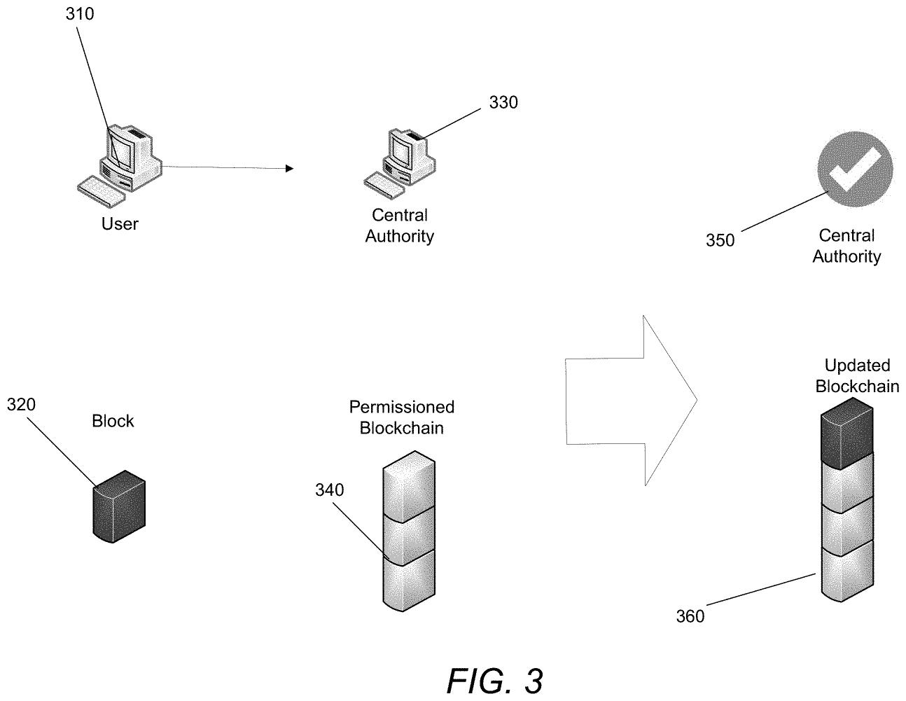

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

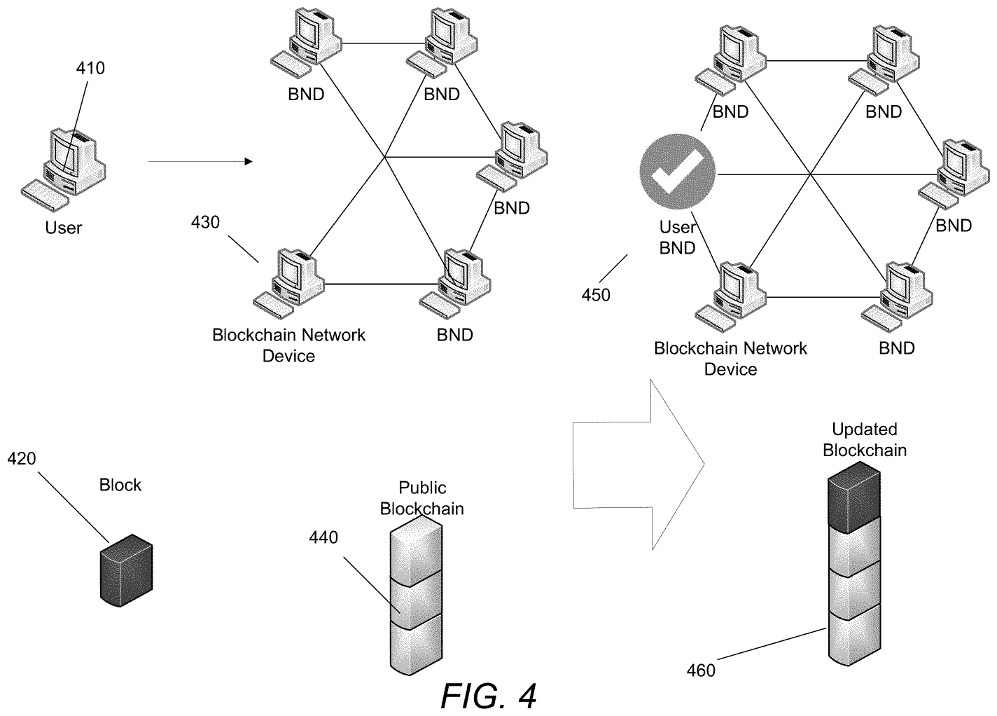

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, proof of stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

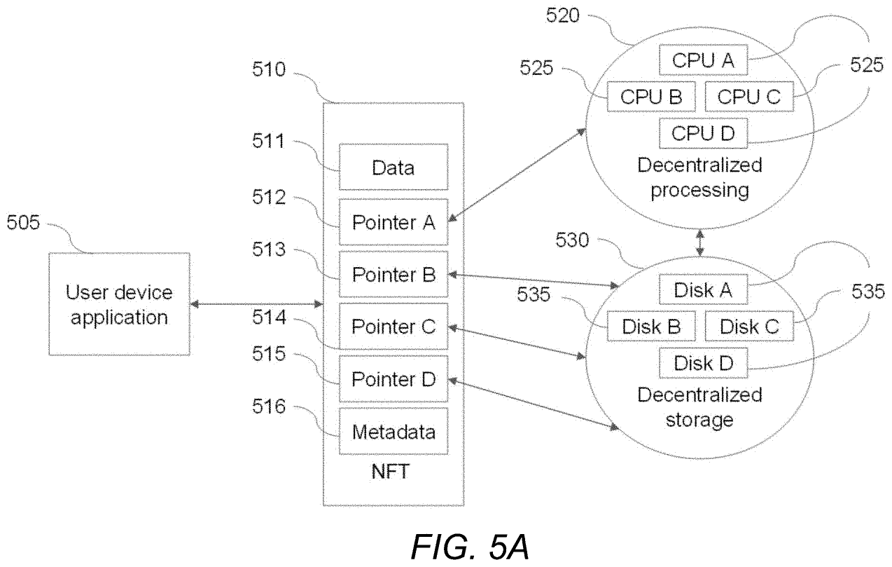

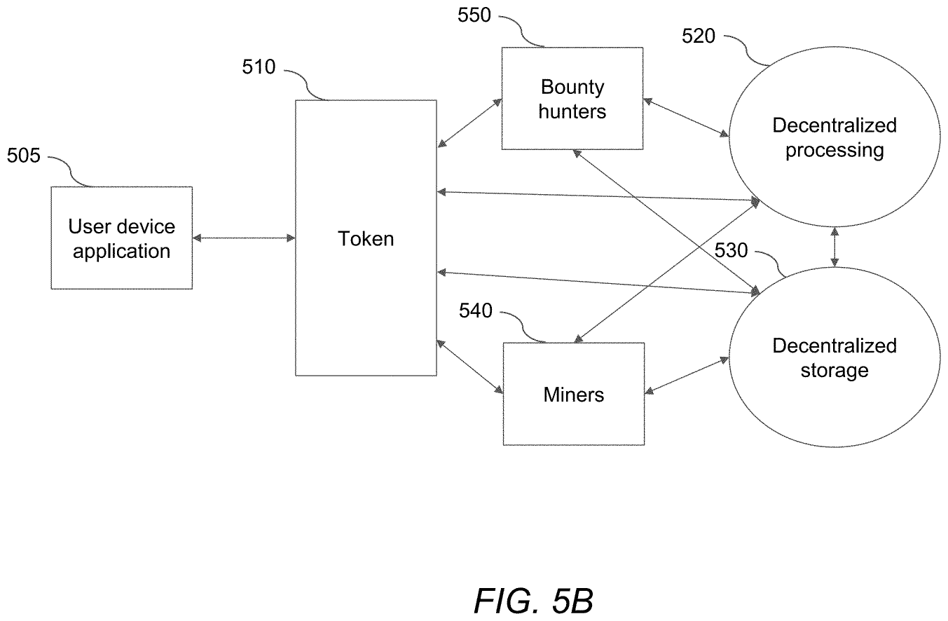

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

An additional benefit of dual blockchains exists in the possibility of incorporating methods for detection of abuse, essentially a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

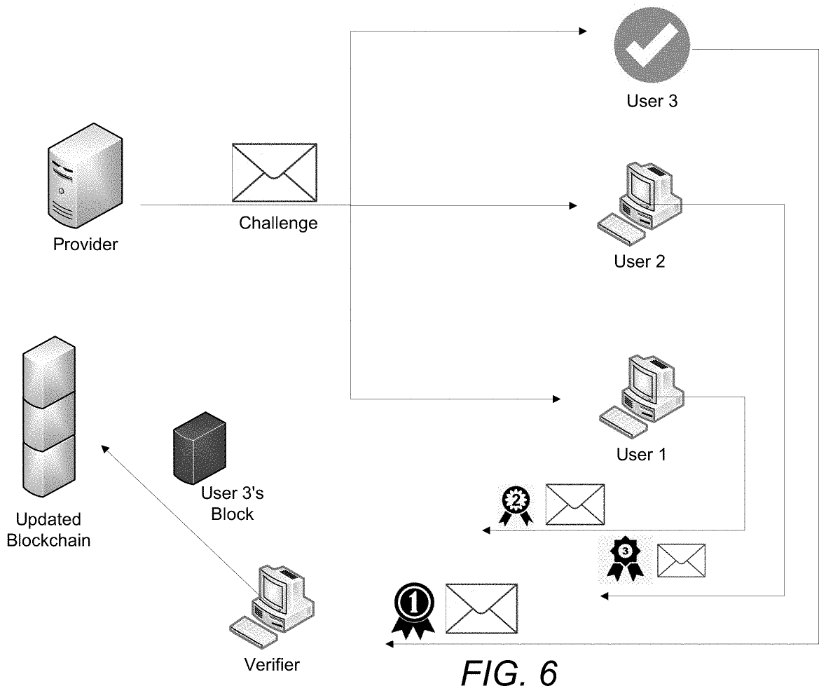

An example of Proof of Work consensus mechanisms that may be implemented in decentralized blockchains, in accordance with a number of embodiments of the invention, is conceptually illustrated in FIG. 6. The example disclosed in this figure is a challenge—response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

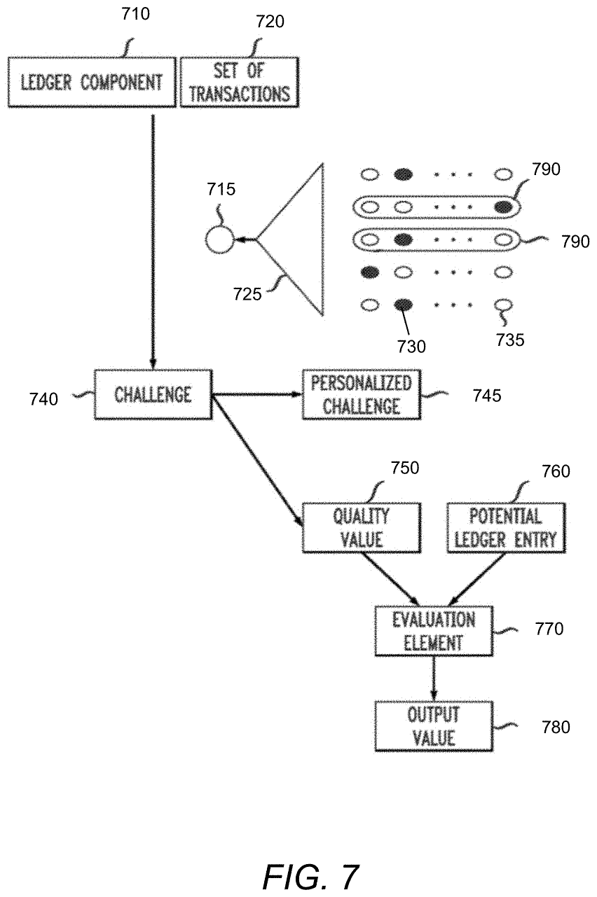

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA-1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also operate as public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

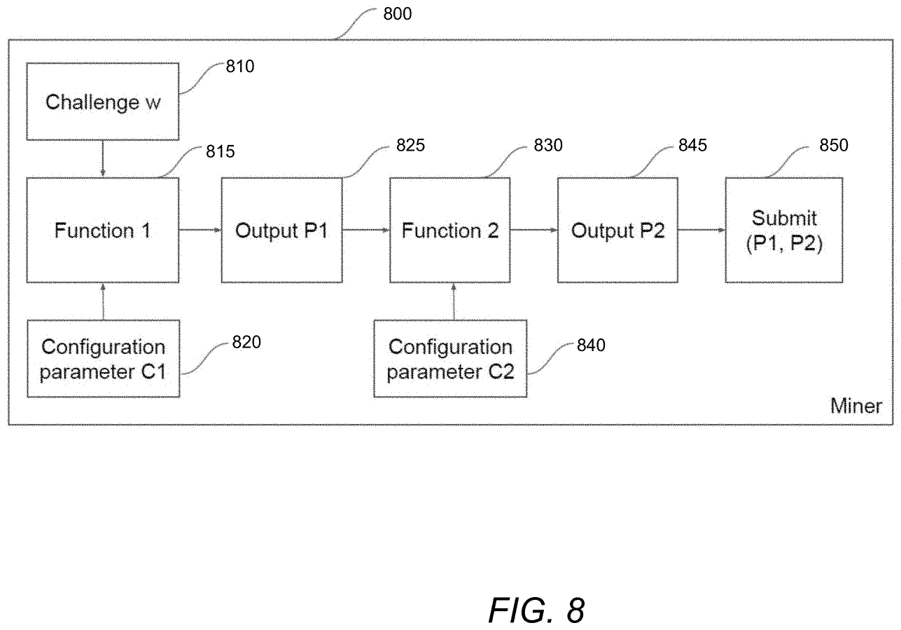

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

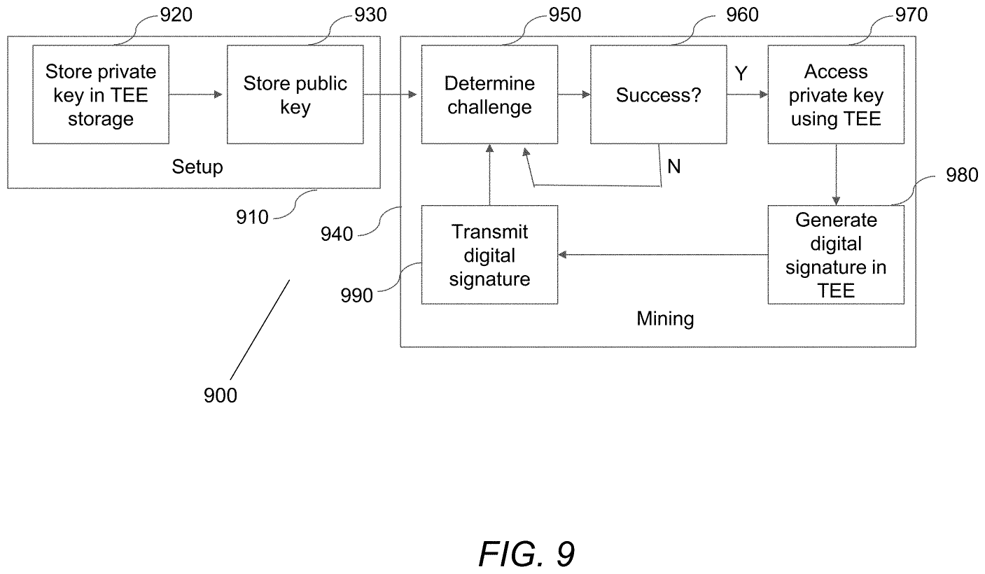

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, proof of stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

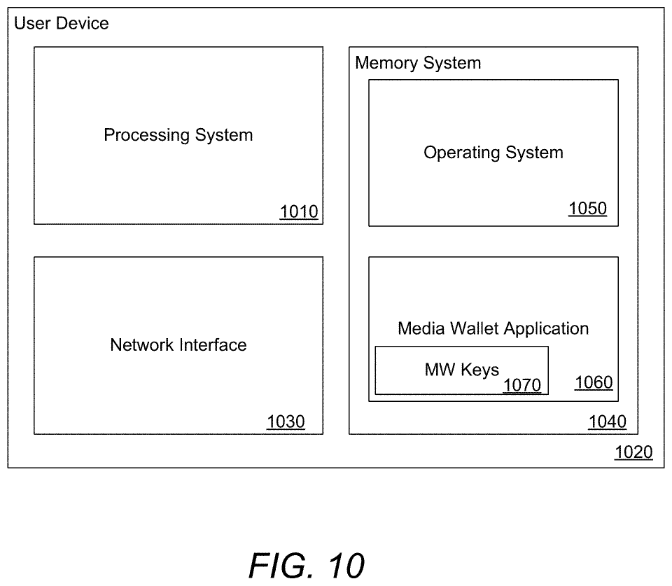

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

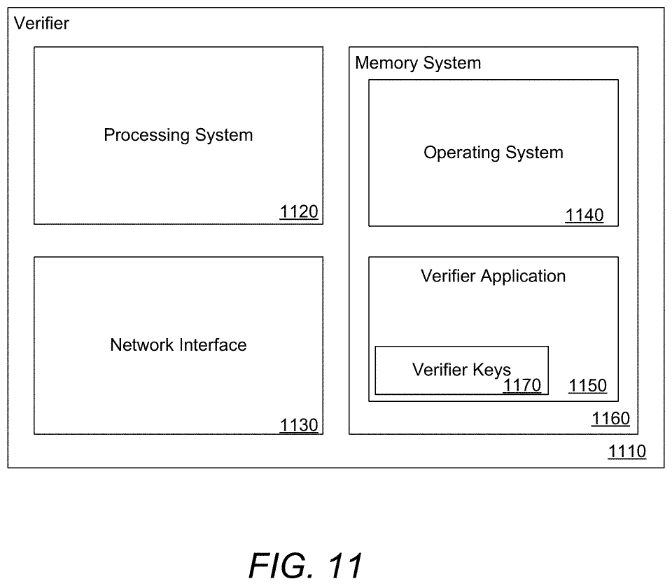

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

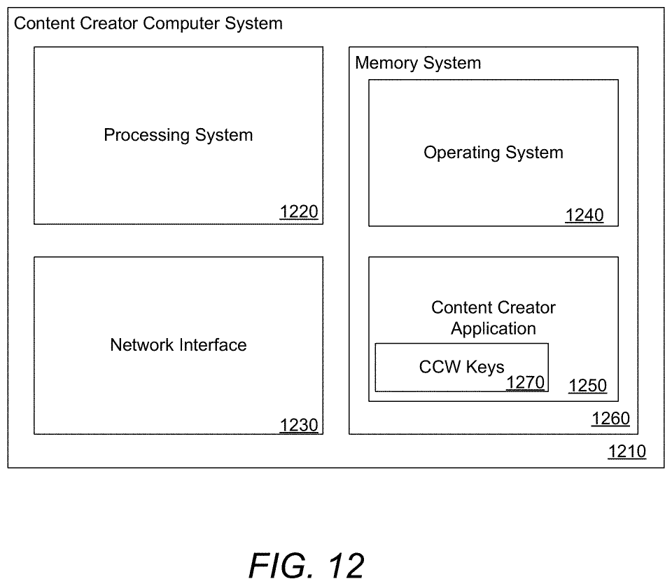

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, digital wallets may securely store rich media NFTs and/or other tokens. Additionally, in some embodiments, digital wallets may display user interfaces through which user instructions concerning data access permissions can be received.

In a number of embodiments of the invention, digital wallets may be used to store at least one type of token-directed content. Content types in accordance with a number of embodiments of the invention may include, but are not limited to, crypto currencies of one or more sorts; non-fungible tokens; and/or user profile data.

In numerous embodiments, user profile data may incorporate logs of user actions. User profile data in accordance with various embodiments of the invention may be anonymized (e.g., redacted, encrypted, and/or otherwise obfuscated) user data. User profile data in accordance with some embodiments may include, but are not limited to, information related to classifications of interests, determinations of a post-advertisement purchases, and/or characterizations of wallet contents.

Media wallets (or media wallet applications), when storing content, may store direct references to content. Media wallets may also reference content through keys to decrypt and/or access the content. Media wallets in accordance with various embodiments of the invention may use keys to additionally access metadata associated with the content. Metadata may include, but is not limited to, classifications of content. In a number of embodiments, classification metadata may govern access rights of other parties related to the content.

Access governance rights in accordance with a variety of embodiments of the invention may include, but are not limited to, whether a party can indicate their relationship with the wallet; whether they can read summary data associated with the content; whether they have access to the peruse the content; whether they can place bids to purchase the content; whether they can borrow the content, and/or whether they are biometrically authenticated.

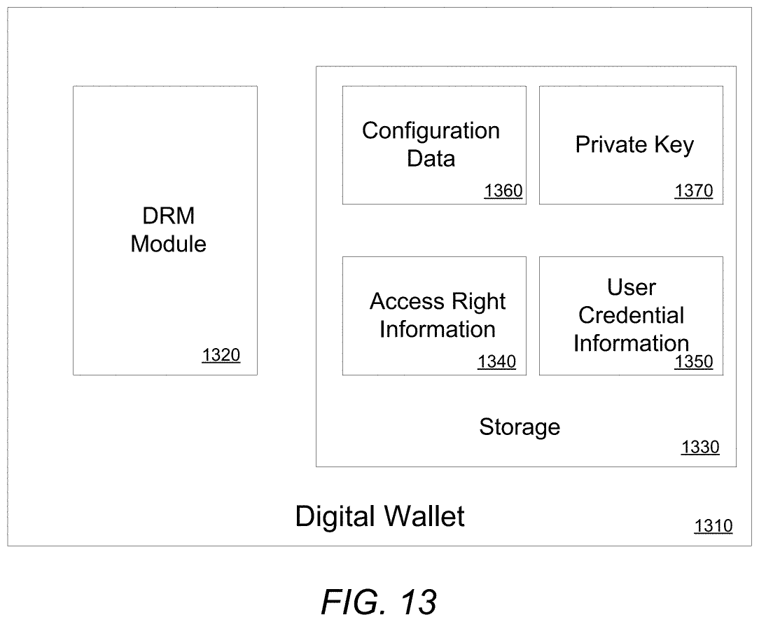

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

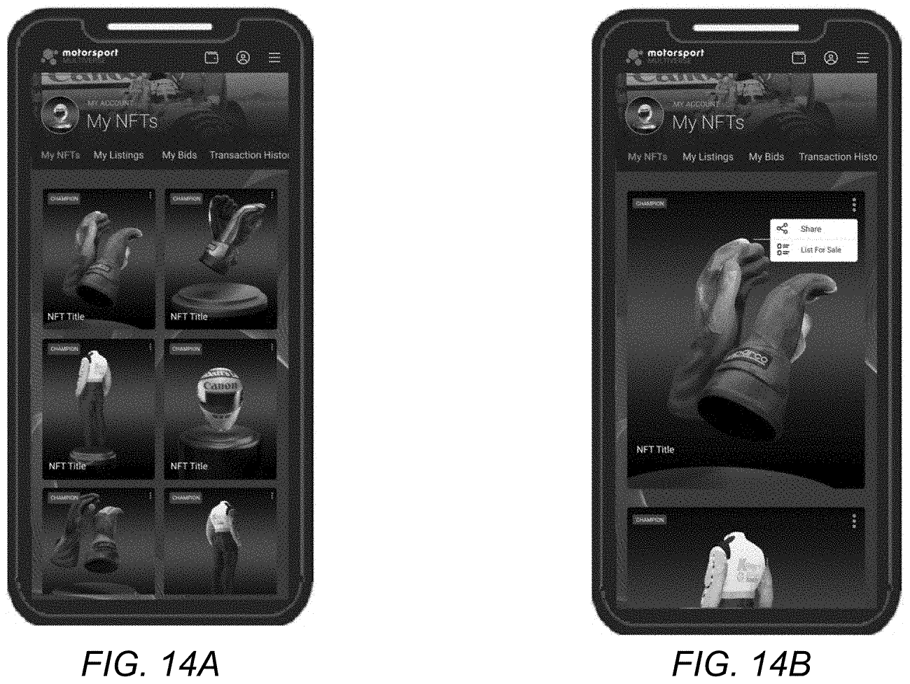

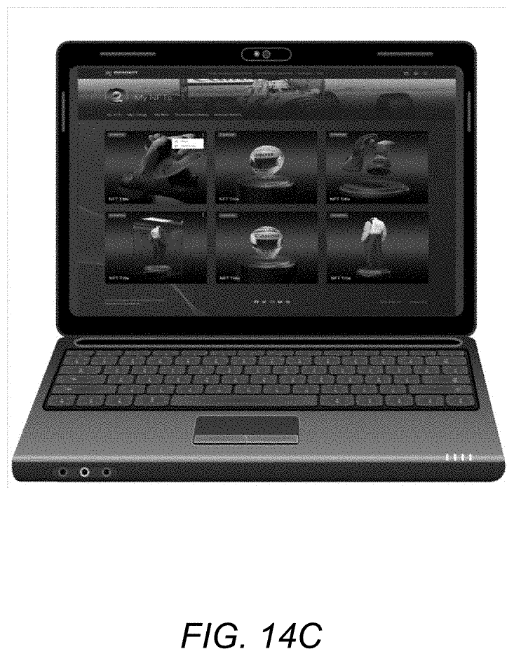

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.”

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT types (or configurations) may be implemented. Some NFTs may be referred to as anchored NFTs (or anchored tokens), used to tie some element, such as a physical entity, to an identifier. For example, anchored NFTs in accordance with certain embodiments of the invention may associate users (e.g., users' real-world identities and/or other identifiers) to a system identifier, such as (but not limited to) a public key. Anchored NFTs applied to identifying users, may be referenced as a social NFTs, identity NFTs, identity tokens, or social tokens. In accordance with many embodiments of the invention, social tokens can contain an individual's personally identifiable characteristics and may be maintained and managed throughout their lifetime so as to connect new information (e.g., via additional NFTs) to the individual's identity. Social NFTs in accordance with some embodiments of the invention may include, but are not limited to, personally identifiable characteristics such as name, place and/or date of birth, biometrics, etc.

In a number of embodiments, social NFTs may assign a first social NFT (e.g., with a DNA print) to a newborn's identity. In this example, the first social NFT might then be used in the assignment process of a social security number NFT from the federal government. In some embodiments, the social NFTs may be associated with rights and capabilities, which may be expressed in other NFTs. In numerous embodiments, additional rights and capabilities may also be directly encoded in a policy of the social security number NFT.

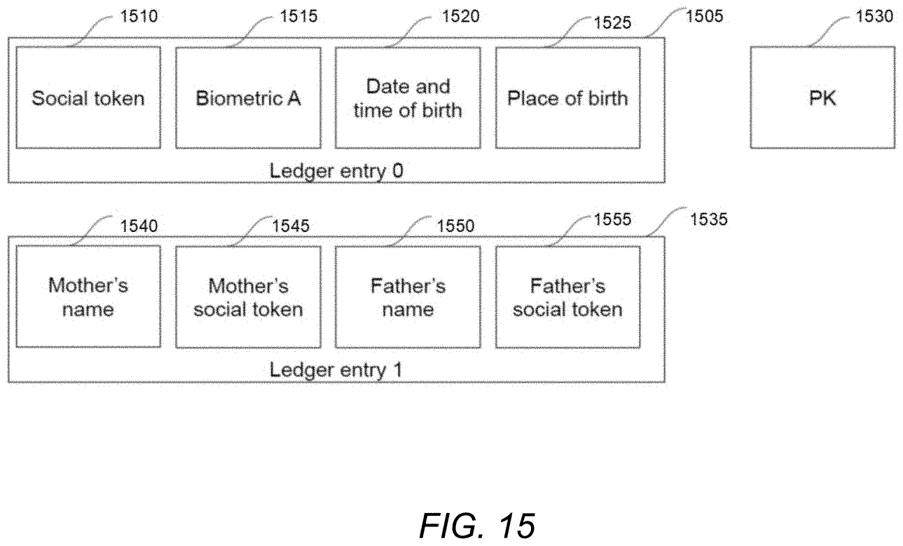

Social NFTs may exist on a personalized branch of a centralized and/or decentralized blockchain. An example of ledger entries on a personalized branch related to an individual's social NFT in accordance with several embodiments of the invention are depicted in FIG. 15. Ledger entries may be used to build an immutable identity foundation whereby identifying information (e.g., biometrics, birth and/or parental information) are associated with an NFT. In the example of this figure, identifying information is protected with encryption using a private key 1530. The initial entry in a ledger, “ledger entry 0” 1505, may represent a social token 1510 assignment to an individual with a biometric “A” 1515. Biometrics in accordance with some embodiments of the invention may include (but are not limited to) a footprint, a DNA print, a fingerprint, etc. The “ledger entry 0” 1505 also includes the individual's date and time of birth 1520 and place of birth 1525. Subsequent “ledger entry 1” 1535 includes parental information with mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race, gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected (e.g., by a bounty hunter and/or some alternate entity). Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

Promise NFTs may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audiovisual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with a first owner and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

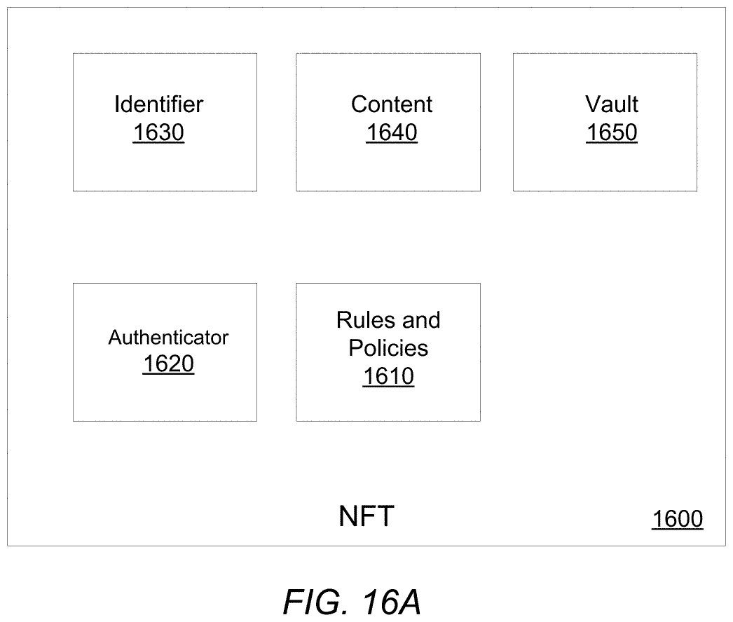

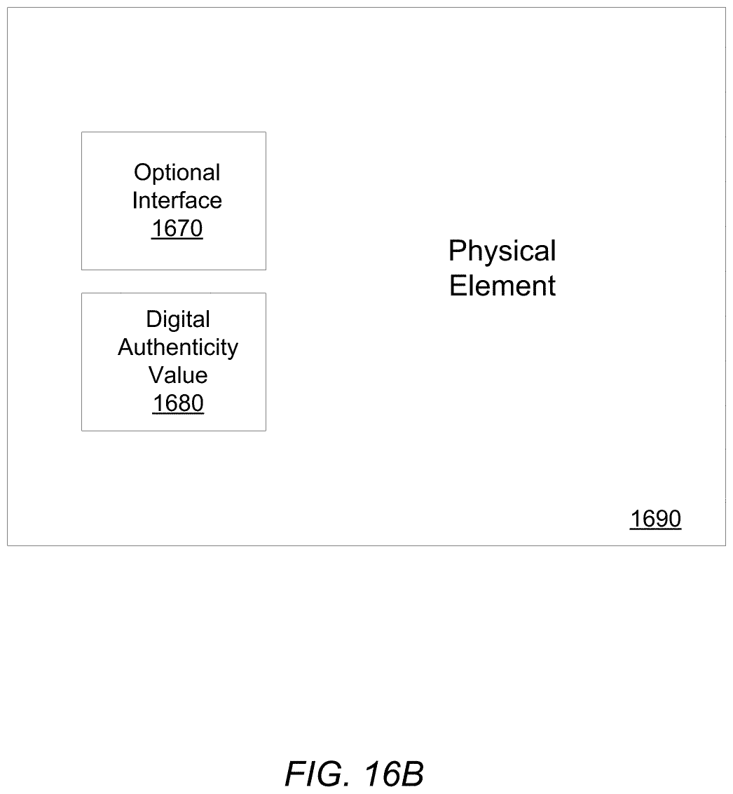

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

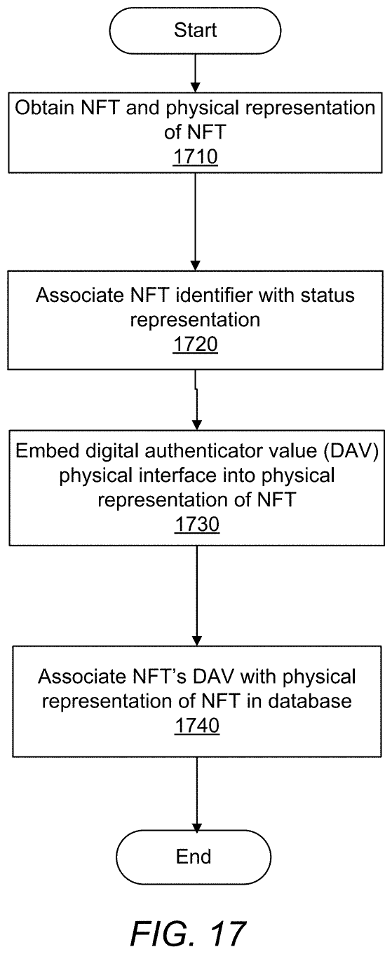

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### NFT Platform Maintenance

NFT platforms in accordance with many embodiments of the invention may implement systems directed to providing automated conditional payments from within an NFT platform to maintain resources including (but not limited to) computer systems and/or sources of data relied upon by the platform. Automated conditional payments in accordance with a number of embodiments of the invention can be conditional on various factors, such as (but not limited to) the provision of services, the occurrence of events, and/or the passage of time. In many embodiments, NFT platforms can assist with the provision of automated conditional payments in various ways, such as (but not limited to) monitoring the provision of services, setting prices for services, and/or executing payments for provided services.

In a variety of embodiments, NFT platforms can provide automated conditional payments using various mechanisms, such as (but not limited to) smart contracts, bounties, and/or data commitments.

Services in accordance with several embodiments of the invention can be provided by service providers and can include (but are not limited to) hosting data. In many embodiments of the invention, one or more payers may be interested in receiving a service. Services may apply to anything for which there is a publicly verifiable condition related to the success of an action, including, but not limited to, NFT off-blockchain storage, hosting, audits, oversight, annuities, query services, resource request routing, and/or access control. Payers may be referred to in the singular, but may not necessarily only be one entity. Similarly, digital resources may include multiple components, and accordingly, so can the service. Services may be defined relative to entire collections of components. For example, a service may include storing a collection of units, and respond to a request for a subset of units with a predefined service assurance level.

In a number of embodiments, one or more competing service providers may each be willing to perform a particular service. Service providers may be separated into different types, including, but not limited to, contracted service providers and uncontracted service providers. In many embodiments, a payer may utilize both contracted service providers and uncontracted service providers. These entities may collectively be referred to as service providers.

In a number of embodiments, one or more service providers can enter an agreement to provide the service, in return for some compensation. Compensation for performance may be indicated in the agreement. Compensation may also be determined through third-party resources, such as a marketplace that determines the appropriate value of the service. Service providers whose continued service depends on external agreements may be described as “contracted service providers”. A Decentralized Storage provider may be considered to be a type of contracted service provider.

In a number of embodiments, no service provider may have contracted to perform a required service for a set duration. In many instances, one or more service providers may still take on the task associated with the required service, but without guarantees of maintaining the service. These parties can be referred to as “uncontracted service providers”. The payment of uncontracted service providers may differ from the payment of contracted service providers.

In order to monitor the performance of services by service providers, NFT platforms in accordance with a number of embodiments of the invention can provide for verification of the provision of a service. Verification of services in accordance with a variety of embodiments of the invention can utilize bounty hunters and/or other verification services. In some embodiments, various methods for monitoring and/or assigning reputation scores to bounty hunters, verifying assertions made by bounty hunters, and/or resolving race conditions can be used to monitor the provision of services. NFT platforms in accordance with various embodiments of the invention can set prices and/or execute payments for services. Some embodiments may utilize a mechanism for transfer of payment from a payer to one or more service providers.

A contracted service provider can receive a series of payments for providing the service over the course of one or more time periods. Service providers that fail to provide their service may also receive punishments, including but not limited to, not receiving one or more additional payments for future time periods during which the service was correctly provided.

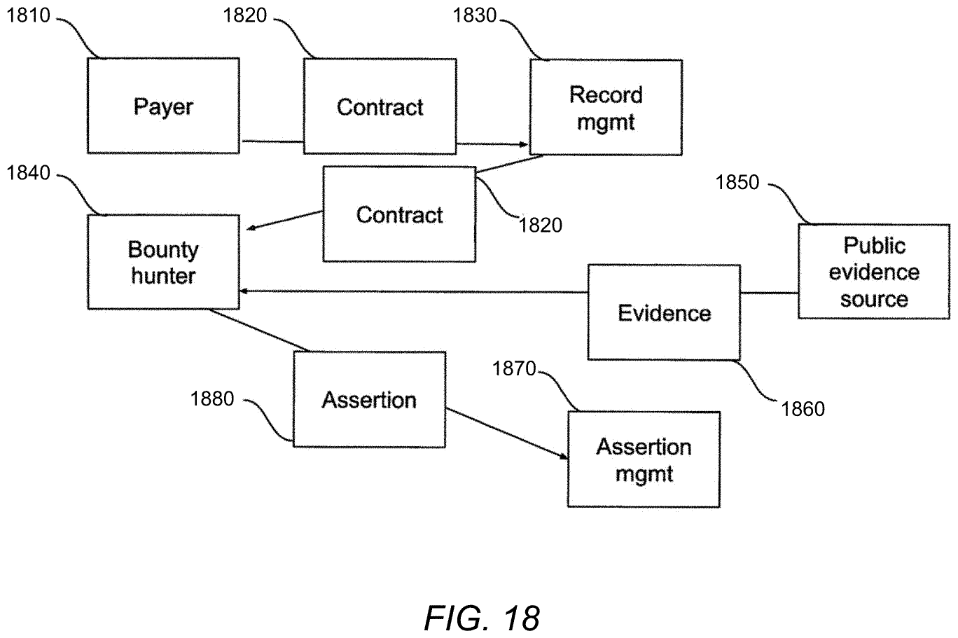

A payment system of operation, in accordance with a number of embodiments of the invention, is illustrated in FIG. 18. In accordance with several embodiments of the invention, a payer 1810 may generate a contract 1820 in order to establish the terms of a service agreement. Configurations of service contracts in accordance with various embodiments of the invention are discussed further below. Once a contract is established and agreed to, the contract may be transmitted to a record management 1830 entity. Record management 1830 may be used to enable a public representation of a contract. Record management 1830 entities may incorporate publicly readable ledgers, to make the contracts publicly accessible. Record management 1830 may incorporate any storage and/or display method to which external parties can have access.

An uncontracted service provider may receive a conditional ongoing payment for providing the service. The condition may specify the current amount of payment. Additionally, the amount of the payment may change based on how many contracted and/or uncontracted service providers also provide the service. In a number of embodiments, uncontracted service providers may not be obligated to provide the service, and may not be penalized for not doing so.

In many embodiments, the payment of a service provider may be governed by a collection of miners. Miners, in the context of cryptopayment schemes may be computational entities that perform proofs relative to a challenge. In a number of embodiments, miners may perform these proofs in order to facilitate closing ledgers with zero or more entries.

Closing ledgers may be used to approve the payment transfers in accordance with a number of embodiments of the invention. Closing may be performed by generating cryptographic proofs that depend on having access to resources. Proofs relative to challenges may be generated, at least in part, from the zero or more entries of the ledger. Since proofs may require access to limited resources, completion of proofs may be difficult. Miners that succeed in completing proofs may have performed a service by closing the corresponding ledger, and time-stamping the zero or more entries in the ledger relative to previous ledgers.

The resources, on which proofs require access, may be computational resources (“proof or work”). BitCoin is an example proof of work based cryptopayment scheme, and is incorporated by reference. The resources may also be storage resources (“proof of space”). The resources may also be a combination of storage and computation resources (“hybrid proof” or “dual-proof”).

Compliance to contracted and/or uncontracted agreements may be externally facilitated by entities referred to as “service bounty hunters” 1840. If a service is being performed and/or contracted to be performed by a service provider, service bounty hunters in accordance with some embodiments of the invention may determine whether the service matches a specific quality assurance level. Quality assurance may be determined by methods including, but not limited to a contract, industry standard, and/or common consensus. To make this determination for contracted service providers, service bounty hunters 1840 may access record management 1830 to receive representations of existing contracts 1820.

Service bounty hunters 1840 can provide an assertion 1880 relative to the provision of service by one or more service providers. For example, a service bounty hunter 1840 may provide an assertion that a first contracted service provider failed to provide the service agreed to in their contract, for a first time period. Service bounty hunters 1840 may also provide assertions 1880 that a first uncontracted service provider provided a service relative to a specified resource. This resource may, for example, be an NFT.

Assertions may be made to one or more miners on a blockchain. The assertions may be provided directly to miners by broadcasting the assertion and/or posting it to a bulletin board. Bulletin boards may include publicly available ledgers on which the miners operate.

The validity of assertions may depend on evidence of failure and/or success in providing a service. To affirm their assertions, the service bounty hunter 1840 can access public evidence sources 1850 and collect evidence 1860 related to the contract 1820. The assertion 1880 may include a reference to the contract 1820 and a reference to evidence 1860. For example, a bounty hunter may access all sources of data referenced within the bytecode of a smart contract written to an immutable ledger (e.g. an NFT) to verify the availability of the data relied upon to execute the byte code associated with the smart contract.

Service bounty hunters 1840 may then transmit the assertion 1880 to an assertion management 1870 entity. Assertion management entities in accordance with a number of embodiments of the invention may include any storage to which other parties have access.

In some embodiments of the invention, race conditions may produce ambiguity regarding the first of a plurality of service bounty hunters 1840 to post an assertion 1880. To protect against race conditions, service bounty hunters 1840 may first post commitments to their assertions 1880.

In a variety of embodiments, commitments may be used to avoid assertions being stolen by competing service bounty hunters, instead of publicly posting an affirmation of the existence of the assertion. An example commitment approach may be to generate and post a cryptographic hash of an assertion and a random nonce. In a subsequent ledger, the bounty hunter that posted the commitment may then post a corresponding decommitment, which includes the assertion 1880. For example, a corresponding decommitment may involve posting a reference to the commitment along with the assertion and the random nonce.

For example, an assertion may be produced that includes an evidence component E and a public key component P. The commitment to the assertion may=hash(E, P, R) where R is an optional random number, such as a 128-bit random string. The service bounty hunter that found E and who owns P may also thereby have access to the secret key S corresponding to P. The commitment may then be generated and submitted to a first ledger.

The first ledger may use the contents of ledger as a challenge, including the submitted commitment. This may end up leading to a successful mining and closing of the ledger. A second ledger entry may subsequently be generated by the system. As such, a successful mining effort to close the second ledger may use, in its challenge, the contents of the second ledger as well as a reference to the first. As the second ledger would be timestamped, when the service bounty hunter decommits by submitting a decommitment=(E, P, R), an ordering can still be established. If the second ledger has closed by the time the decommitment is received, the decommitment may be posted to a third ledger that is subsequent to the second ledger.

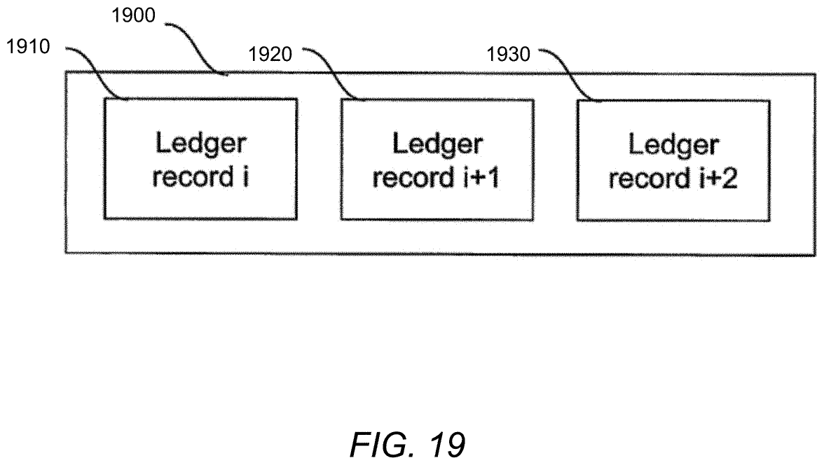

An example of a ledger incorporating a plurality of ledger entries is depicted in FIG. 19. FIG. 19 shows a portion of a ledger 1900 including a first ledger record 1910, a second ledger record 1920 and a third ledger record 1930. Additional ledger data may include a value computed from first ledger record 1910. This value may be a cryptographic hash value of the first ledger record 1910. This may establish that the second ledger record 1920 is the successor ledger record of first ledger record 1910. Similarly, the third ledger record 1930 may include an element that is computed from second ledger record 1920, thereby establishing that third ledger record 1930 is the direct successor of second ledger record 1920. This can establish an ordering of the ledger records 1910, 1920 and 1930 of ledger 1900.

Through the commitment and decommitment, verifiers in accordance with a number of embodiments of the invention may determine (a) that the commitment was posted prior to the decommitment, and (b) whether the E is valid evidence. If the verifier determines that E is valid, the verifier can assign a value to P, the public key.

Similar processes in accordance with a variety of embodiments of the invention may be used to foil attempts at plagiarizing another service bounty hunter's evidence. A competing bounty hunter may not create a competing commitment based on the initial commitment, as they would not know the contents. Specifically, the commitment may only be accessed by a party that also has the decommitment.

The plagiarizer also would not benefit from simply posting a copy of the commitment. Since the commitment would be a hash of the evidence (E), the random number (R), and the original service bounty hunter's public key (P), the imitation commitment being verified would only assign value to P. As the competing bounty hunter would not know the secret key corresponding to P, there would be no benefit.

Additionally, the competing bounty hunter would not be able to find an alternative decommitment (E, P2, R2) such that C=hash(E, P2, R2). Due to the collision-freeness property of cryptographic functions, the hash of the second set would not be able to also produce the commitment.

In several embodiments of the invention, a verifiable delay function (VDF) can be used to avoid race conditions, in which a cheating bounty hunter attempts to replicate an assertion made by another bounty hunter. The VDF may refer to a type of proof of work that requires a small or moderate investment of effort. VDFs can be achieved in a traditional manner using proof of work techniques, wherein the level of difficulty is set sufficiently low, while also being sufficient to avoid race conditions in most cases.

In various embodiments, a service bounty hunter may avoid race conditions by acting as a miner and including the assertion in the ledger locally. In this case, once the ledger is closed using mining, the local entry and the time-stamped closing may be disclosed at the same time. This may improve the quality score of the mining instance and give a preference for the service bounty hunter/miner in cases where two miners suggest potential ledger closings at essentially the same time.

An additional approach may be for contents to an open ledger entry to refer to each other. In doing so, the ledger may form a directed acyclic graph (DAG) to create an ordering. Thus, in order to win a race condition, an attacker would have to benefit from the low likelihood that the subsequent ledger entry contents incorrectly refer to the copied assertion as preceding the original assertion.

In some embodiments, digital signatures may be used to prevent race conditions. This can be implemented as follows: A client, intending to act as a service bounty hunter, generates a digitally signed request (e.g. an HTTP/HTTPS request). In return the client may expect the host response to include digital signatures of any content associated with the service (e.g. on-chain NFTs). The client can generate a digital signature of the request where the request includes (but is not limited to) a query URL, a service provider URL, a timestamp, and/or a hash of the request=hash(query URL, service provider URL, timestamp). The client may submit the query and signature to the service provider.

In many embodiments, if the service provider performs their obligation, this method may be used to receive evidence of such. When service provider accepts the client signature, they can generate a digital signature. Digital signatures in accordance with a number of embodiments of the invention can include (but are not limited to) a hash of the client signature, a hash of the resource, and/or a timestamp. The site can then respond to the client with the contents of the resource along with the site digital signature. The client may compute a hash of the received resource. The client may then have the resource and a signature from the service provider showing that the client originated the resource query and that the service provider responded with the resource.

The client can then submit an assertion to affirm their possession of the resource. The assertion may include of the service provider identity, the service provider's digital signature, and the client's digital signature as proof of the transaction. In embodiments where the resource is an NFT, the client may optionally check the resource's hash against the blockchain registered NFT, or against the hash provided by a DNS service, and verify that the service provider is licensed to supply the resource. Upon doing so, they may submit an assertion against any infringing service providers.

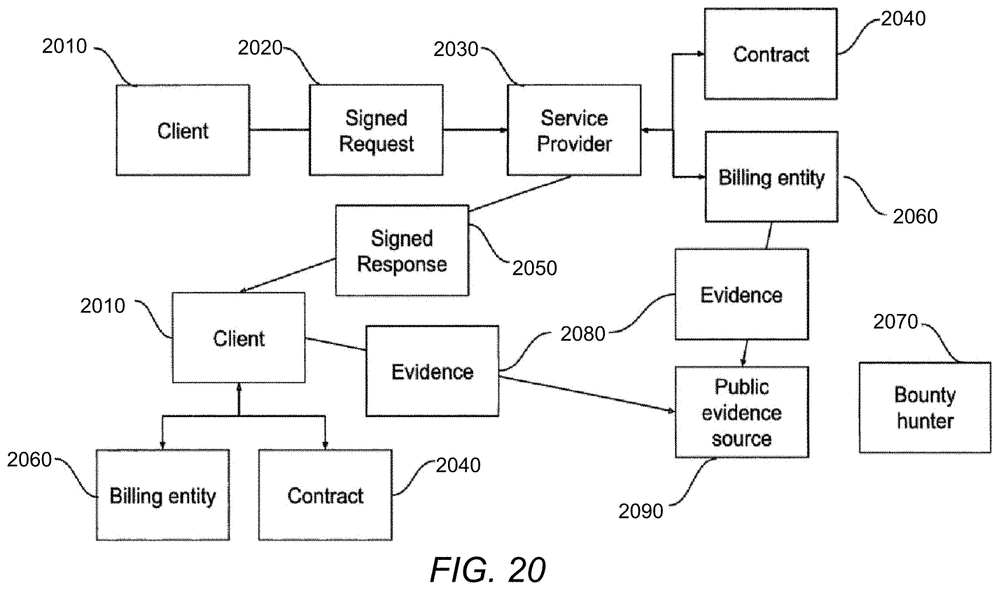

An example process wherein a client acts as and/or on behalf of a service bounty hunter is illustrated in FIG. 20. The client 2010 can submit a digitally signed resource request 2020 to a service provider 2030. The service provider 2030 may accept the signed request and reference the contract 2040. The contract 2040 might refer to terms including, but not limited to hosting fees to be paid to the service provider 2030, advertising fees to be paid to client 2010, and other bounty fees to be paid to the client, service provider, and/or other bounty hunter referencing public evidence source 2090. The service provider can digitally sign the content associated with the contract 2040. The service provider 2030 may submit a signed response 2050 that includes the digitally signed content and the contract 2040 to the client 2010. The service provider may optionally submit the signed request 2020, signed response 2050, and contract 2040 to the billing entity 2060. The service provider may also optionally submit evidence to the public evidence source 2090. The client 2010 can compute a hash of the received resource and reference the contract 2040. The client may submit evidence 2080 that includes of the signed request 2020, the signed response 2050, and the contract 2040 to the public evidence source 2090. The client may optionally submit evidence to the billing entity 2060.

Another aspect of bounty hunting in accordance with a variety of embodiments of the invention may involve collecting advertising fees. For example, a client, intending to act as a service bounty hunter may generates a digitally signed request (e.g. HTTP/HTTPS request). In return, the client may expect the host response to include digital signatures of advertising content associated with an on-chain NFT. The client can generate a digital signature of the request. Requests in accordance with a variety of embodiments of the invention may include (but are not limited to) a query URL, a service provider URL, a timestamp, and/or a hash of the request=hash(query URL, service provider URL, timestamp). The client may then transmit the query and signature to the service provider. The service provider accepts the client signature.

If the service provider performs their obligation, digital signature methods in accordance with certain embodiments of the invention may be used to receive evidence of such. For example, when a service provider accepts a client signature, service provider can generate a digital signature. In some embodiments, digital signatures can include (but are not limited to) a hash of the client signature, a hash of the resource, and/or a timestamp. The site can then respond to the client with the contents of the resource along with the site digital signature. The client may compute a hash of the received resource. The client may then have the advertisement resource and a signature from the service provider showing that the client originated the resource query and that the service provider responded with the advertisement resource.

In accordance with many embodiments of the invention, advertisements may provide both a form of digital content and a monetization approach. Thus, another incentive for participants, including but not limited to bounty hunters and service providers, to perform their respective duties may be to obtain the rights to show content consumer advertisements. Content providers can select in contracts whether to pay for services (such as the display of NFTs). They may also select to allow the provision, up to some maximum amount, of advertisements in tandem with the provided services. The nature of these advertisements may be dictated in the contracts, to protect content owners from being matched up with advertisements that taint their brands. Advertisement originators may have independent agreements with service providers, paying them in exchange for the advertisements being shown. The selection of advertisements may depend on the origin of the request for content (e.g., NFT) and associated demographic information known about particular content consumers.

Content consumers may choose to enable the creation of a profile about them, which can make them more valuable targets for advertisements. Service providers may get paid more when an advertisement is shown to a content consumer about which more demographic information available. This may allow the number of advertisements shown to such consumers to be limited relative to what a consumer with no profile would be shown, as a way to incentivize content consumers to permit the generation of a profile about them. Such a profile may include demographic information assessed from traffic patterns (e.g., what content is requested), IP address information, and/or known purchase information.

Profile information may be maintained by content consumer and/or representatives thereof. The information may also be maintained by service providers. For example, this may happen with a service provider that performs routing of requests based on NFT identifiers in the request. Routing may be performed to service providers that host the content of the NFT. Routing may also be used to facilitate metering or other demographic assessments. Thus, one or more parties on a route may generate profiles for users, where the inclusion of information in a profile may be conditional on information indicating what type of profiling is acceptable and conveyed by the content consumer in the content request. Therefore, this information may be used to convey privacy preferences, and can be interpreted by parties building profiles.

Bounty hunters may identify cheating parties building profiles by requesting that no profiles are built and observing whether this is respected. For example, the observation may uncover the presence or absence of a profile indicating a preference and/or history of requests. Discovering advertisement profile-based cheating may be much more financially rewarding than discovering unintentional failures to provide service.

Another aspect of bounty hunting may include checking for latency, throughput, and frequency of query service to a given provider. Assuming that NFTs are intended to generate revenue, the provider can be motivated to achieve superior performance. Client application may additionally desire to report statistics on providers (the serving URL, latency time, throughput, the hash for the NFT).

In a number of embodiments, service providers may be storage facilities that store data. The storage facilities may also allow users to retrieve such data when desired with pre-defined and/or customary quality of service levels. For example, a service provider may store information in ways including, but not limited to, an image in a jpg file, a music video as an mpg file, and a script as a JavaScript file with associated data containers. Contracts may also specify the typical quality of service expectations and availability requirements. A given contract may also allow and/or limit the ability of a service provider to re-sell and/or outsource their service.

In many embodiments, the service provider may be in charge of routing requests for resources and to select secondary service providers that store resources which may be the data described in the embodiment above. For instance, this may be the case for a DNS service or a URL shortening service. The resource might be identified by a unique URL generated by the resource originator. The resource may also be identified by a secure hash such as SHA-256 generated from the contents of the resource, and/or by other unique identifiers.

When a request for the resource is received by the service provider, the request may be redirected to the location where the data is stored. That location is with the secondary service provider at the time of the request. This location may change as the service provider renegotiates contracts with one or more secondary service providers.

A primary service provider may refer to a service provider that has a direct agreement with a payer. Primary service providers may also establish contracts with one or more secondary service providers. Secondary service providers in accordance with a number of embodiments of the invention may be decentralized storage providers. The contract between the primary service provider and the one or more secondary service providers may be public, to allow identification of failures by the secondary service providers. However, a primary service provider may also be liable for any failures of service provision by the secondary service provider. Alternatively, or conjunctively, they may otherwise be in charge of penalizing secondary service providers that fail to perform the contracted service.

This may be a second duty of service providers: to determine on a periodic basis whether the secondary service provider for a given resource is well chosen. This determination may be based on quality of service, price, assurances, etc. Secondary service providers may be changed periodically to optimize the performance of the system. Changes in secondary service providers may not require involvement of the payer.

The primary service provider therefore may facilitate contracts with one or more secondary service providers. The contract between primary service providers and the one or more secondary service providers may be public, to enable service bounty hunters to also identify failures by the secondary service providers. However, the primary service provider may also be liable for any failures of service provision by the secondary service provider. In cases where the primary service provider is in charge of penalizing secondary service providers that fail to perform the contracted service, the contract between the primary service provider and the secondary service provider may not be public. Additionally, any hierarchy of cooperating service providers may collaborate to provide a service to the payer.

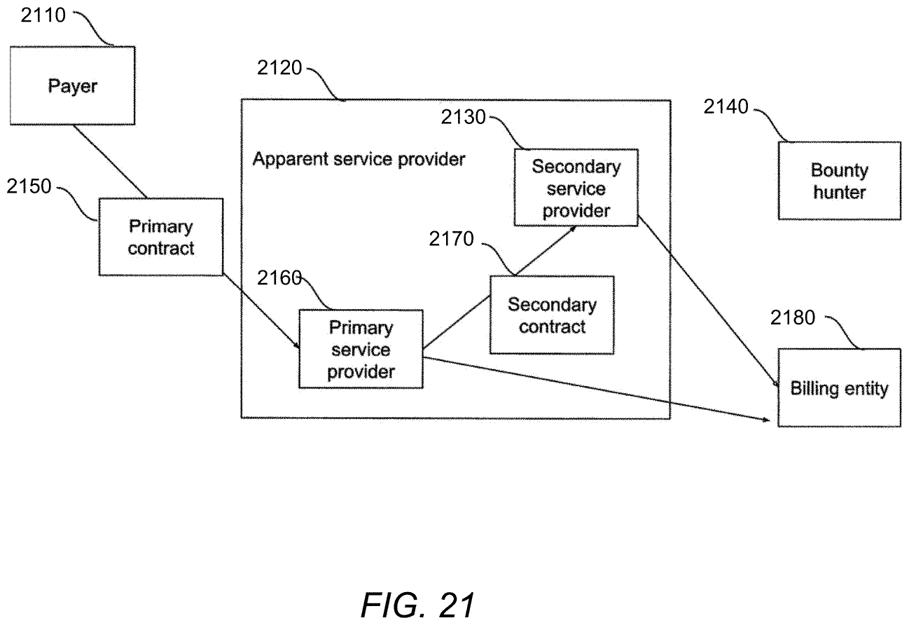

A setting in which multiple service providers collaborate to provide a service, in accordance with a number of embodiments of the invention is illustrated in FIG. 21. A payer 2110 can generate a primary contract 2150 with a primary service provider 2160 to arrange to provide apparent services to the payer 2110. In doing so, the primary service provider 2160 may act as an apparent service provider 2120 to the payer.

Acting as apparent service provider 2120, may not require the primary service provider 2160 to directly provide the apparent services to the payer 2110. In several embodiments of the invention, the contract 2150 can make the primary service provider 2160 liable for the apparent services to be provided to the payer 2110. The primary service provider 2160 may select one or more entities such as the secondary service provider 2130. In doing so, the primary service provider 2160 may set up a secondary contract 2170 with the secondary service provider 2130.

For example, apparent services corresponding to the apparent service provider 2120 may be to direct a content request to a host that stores the requested data and cause metering of access for purposes of billing and royalty payments, and to guarantee a minimum level of a quality measure for the service. This may be specified in a primary contract 2150. However, the primary service provider 2160 can provide the service of selecting a hosting service, verifying its quality of service, periodically determining whether to re-select a hosting service, and moving content when applicable. The secondary service provider 2130 may host content and respond to requests for content.

Both the primary service provider 2160 and the secondary service provider 2130 can perform metering by reporting access to a billing entity 2180. This may be done where billing entity 2180 compares reports from the primary service provider 2160 and the secondary service provider 2130 and performs billing and royalty payments.

In addition, there may be multiple options to be informed of discrepancies between service and payment. The billing entity 2180 can report any reporting discrepancies to the payer 2110. Further, the bounty hunter 2140 may identify failures to provide service according to the primary contract 2150 and the secondary contract 2170. The bounty hunter 2140 may report any such failures by generating assertions. These assertions can be used to determine the source of the failure, e.g., whether the primary service provider 2160 and the secondary service provider 2130 or both were responsible for a given observed failure.

The primary service provider 2160 can replace the secondary service provider 2130 based on a determination related to the quality of service associated with the secondary service provider 2130 and/or based on finding another service provider providing a better quality of service or lower charges. Thus, the first service provider 2160 may periodically renegotiate service agreements such as the secondary contract 2170 to maximize the quality of service level and/or minimize the costs of service, where savings in costs of service may in part benefit payer 2110 and in part benefit the first service provider 2160 according to policies specified in the primary contract 2150.

In a number of embodiments, one or more service providers may be used to meter access, for purposes of calculating royalties. For example, when a primary service provider forwards and/or redirects traffic to the location of storage, this may indicate that a billable event is in the process of taking place. Such billable events may be logged. Logging may be performed in multiple locations and by multiple service providers. If logging is performed separately, it may be later aggregated and compared for accuracy. In some embodiments, metering may also be used to determine payments to service providers, such as a secondary service provider that may charge per access. This may contrast and/or be in addition to a static fee per time unit of being available to perform the service.

Metering may be implemented in a wide variety of modes. For example, they may also be reflected in one or more contracts related to the service provision. Techniques used for digital rights management (DRM) may also be adopted using the techniques disclosed herein.

In some embodiments, NFTs may be intended to generate revenue through licensing (music, art work, code snippets). In such cases, a service bounty hunter may be used to ensure that proper licensing fees can be paid.

In a number of embodiments, access control may be a concern for payers. For example, a web browser (client) may check all assets on a page against all well-known NFT databases (blockchains), and ensure that the web site owns a fractional NFT for those assets. The client might refuse to present any content that is not licensed. The client might consider any non-NFT code to be suspect and/or possible malware. The client might report non-NFT assets back to a decentralized authentication service for further examination, looking for modified original works (for example images where a few pixels were changes or a filter applied in order to defeat hash checking, or code where the text was modified but the behavior is recognized), or for malware detection.

In a number of embodiments, a service provided by service providers may be access control. For example, an NFT owner may specify that anybody with a first token issued by the owner may have full access to the NFT. Anybody presenting a second type of token may be given full read access to the NFT data, including full rendering rights. A third token type may be associated with being able to render the NFT at a specific maximum resolution, and/or on a list of approved device types. A fourth token can allow the NFT holder to access the NFT after viewing an advertisement. A fifth token may allow the holder to access the NFT after paying a sum to a representative of the owner. Payment in this case may be done by posting a payment relative to the NFT and to a specified public key, to which the payment is associated, and providing evidence of this payment to the service provider that limits access.

In a number of embodiments, service bounty hunters may attempt to gain access to a resource without fulfilling the requirements associated with the tokens, which are associated with the service provider performing access control. They may attempt to gain access in order to provide evidence of cheating by this service provider and thereby earn a bounty.

In a number of embodiments, multiple independent parties may perform the tasks of access control gates. For example, the access controllers may be connected serially. If so, to access a resource, a user may first have to present a token to a first access control service provider, who after verifying the correctness of the presented token, may generates an access token to the party. The access token may be presented to a second access control service provider, potentially along with the same token presented to the first access control service provider. This may be done in order for the second access control service provider to provide access to the resource. Access may be granted by providing a second access control token to the service provider that stores the resource (e.g., the NFT).

Parallel access control architectures may be used to increase availability. In a number of embodiments, the second access token can be a decryption key that the user can use to decrypt an encrypted resource. In a number of embodiments, such keys can be generated using threshold cryptographic methods, such as (k,n) secret sharing schemes. Such schemes may require k out on n access control service providers to approve an access based on a token in order for access to be granted and/or to enable decryption capabilities. Here, when (k,n) equals (6,9), it may mean that 6 out of 9 designated access control service providers must agree to produce an access token useful to access the resource with.

Tokens can take many forms, including (but not limited to) a digital signature, a valid contract, a symmetric key matching a known secret key, a value on a hash chain, information matching an access control list (ACL) and/or other access control mechanisms. In a number of embodiments, the token may rely on membership. For example, membership may be of the type that can be expressed using Microsoft Active Directory™ or competing solutions.

As miners observe posted assertions, they may verify the assertions. Verifying assertions in accordance with many embodiments of the invention may incorporate whether an indicated service was or was not provided. Miners can thereby determine, to the best of their abilities, whether the assertions are true. In some embodiments, miners may indicate what assertions they believe are true by making this information part of the input to the challenge generation used in the mining phase. If other miners, or verifiers in general, agree about the interpretation of what assertions were correct, they may agree on what the challenge is. Therefore, this can influence their decision of whether the coin mined by the miner (that determined whether the assertion was true) should be considered valid.

A quorum agreement may determine whether a given crypto payment, in the form of a coin related to a ledger, is valid. Additionally, the agreement can implicitly relate to whether a given indicated service was provided or not. The latter may be referred to as evidence, where the evidence may either relate to the provision of a service or the non-provision of a service. Here, a service can be anything for which there is a publicly verifiable condition related to the success or failure of an action, where an example action may be the storage of data related to a given NFT.

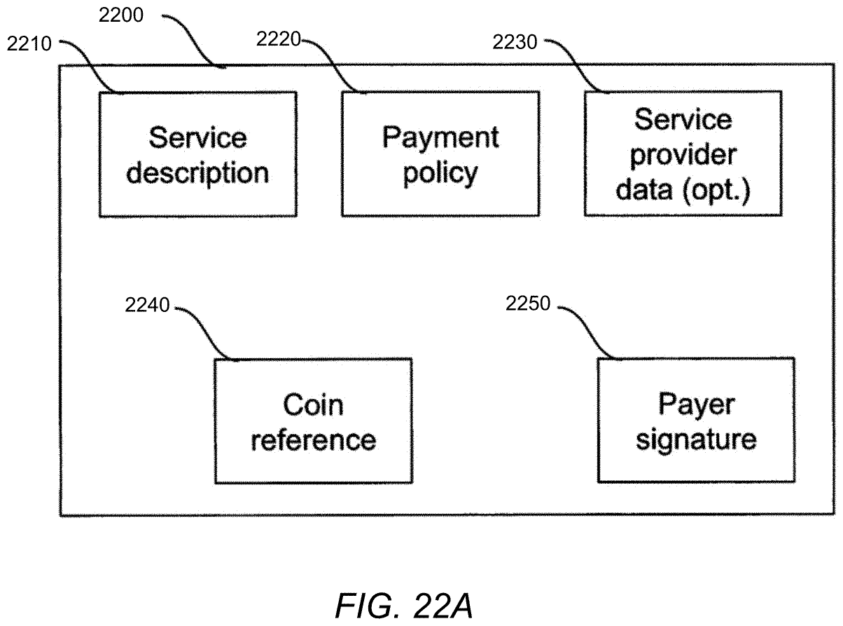

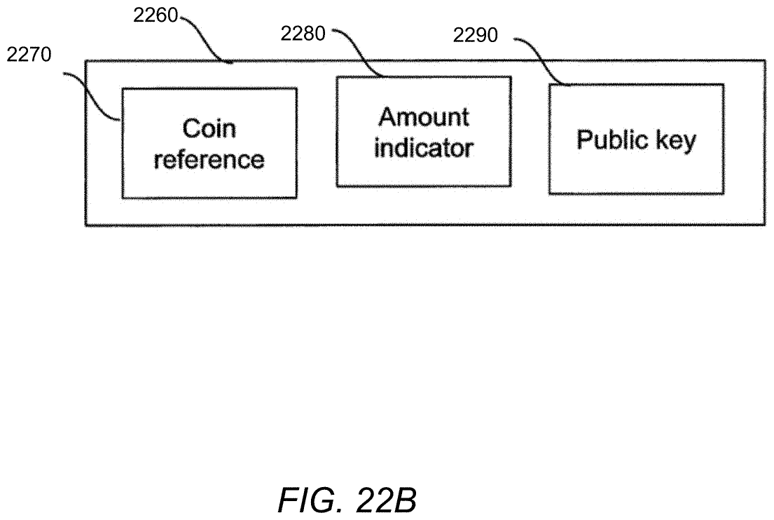

A conceptual illustration of a contract and its facilitation of rewards in accordance with a number of embodiments of the invention is shown in FIG. 22A. A contract 2200 may include, but is not limited to, a service description 2210 that details what service is expected; and a payment policy 2220, including at least one policy or description detailing under what conditions service providers will be paid, and how much. The payment policy 2220 may also detail how much a service bounty hunter, with a valuable and valid assertion, may be paid in response to submitting assertion to an assertion management unit. Such information may also be stored elsewhere and be applicable to different classes of services, which may then be referenced in the service description 2210.

The contract 2200 can optionally include service provider data 2230. If the contract relates to a contracted service provider, service provider data 2230 would include one or more identifiers associated with one or more service providers that are contracted to provide the service described in service description 2210, and one or more digital signatures generated by said one or more service providers attesting to their agreement to provide services. The agreement to provide service may also be stored externally to contract 2210, such as in a separate record stored in record management. If the contract does not specify a given service provider, but relates to a service that is to be provided by non-contracted service providers only, then service provider data 2230 may not be included.

The contract 2200 can also include a coin reference 2240, which can be a reference to data that indicates financial resources. The coin reference 2240 may also include a public key for which the associated secret key may be accessible to the payer and/or an entity assisting the payer with generation of payments and contracts. The data that indicates financial resources may, for example, be what is referred to as a coin. A coin may be generated in one or more ways as described in this disclosure.

The payer signature 2250 may be a digital signature that utilizes the secret key associated with the public key that is indicated by coin reference 2240. The payer signature 2250 may be on a message that includes at least portions of service description 2210, payment policy 2220, and optional service provider data 2230.

After the performance of a contract, a contract may use the payer's digital signature to authenticate the service provider's payment. A digitally signed message, in accordance with a number of embodiments of the invention, is illustrated in FIG. 22B. A message 2260, may include a coin reference 2270; amount indicator 2280; and public key 2290 of the recipient of the payment. A payee can present their public key 2290 to a payer. The coin reference 2270 can indicate the coin from which funds are to be transferred. Meanwhile, the amount indicator 2280 can indicate the amount associated with the coin reference 2270, in the currency of the coin.

The message 2260 can be digitally signed using a secret key corresponding to the public key associated with the coin referenced by the coin reference 2270. The associated digitally signed message resulting from digitally signing the message 2260 in this manner may be a new coin that can now be spent by the owner of the public key 2290. Such spending may be performed by generating yet another digital signature using a secret key corresponding with the public key 2290.

In accordance with a number of embodiments of the invention, one or more policies may be used in determining whether a given assertion is valuable or not. Here, valuable may not be the same as valid. Valid may refer to whether the assertion is correct or not, as judged by the quorum, whereas valuable is determined by the one or more policies, and determines whether the service bounty hunter is offered a reward or not for providing a valid assertion. Policies can be either deterministic or non-deterministic.

Policies in accordance with a variety of embodiments of the invention can be deterministic (determined by the service provided). A first example of a deterministic policy may state that an assertion corresponding to the non-provision of a service by a contracted service provider may be valuable. A second example of a deterministic policy may state that an assertion related to the provision of a service by a non-contracted service provider may be valuable if there exists a contracted service provider for the same resource that did not provide the service. The latter type of assertion may provide a greater reward than the former assertion, when found to be both valid and valuable.

In several embodiments, policies may also be non-deterministic (not determined by the service provided). An example non-deterministic condition may be that a reward may be only offered when the last five bits of a proof challenge can be zero. This means that, since challenges typically can be distributed uniformly at random, that only one out of 2\hat{ }5=32 valid assertions that meet all deterministic policies can be considered valuable, and therefore result in a reward for the service bounty hunter. In the above scenario, the reward may be 32 times the size of what it would have been in a situation where this non-deterministic policy was not in use.

In a number of embodiments, assertions made by a service bounty hunter may include a value that, when an assertion is found by the quorum to be valid and valuable, becomes a payment. The size of a payment can be determined and/or influenced by standards including but not limited to, the one or more policies, the associated contract, when applicable, and common guidelines. One example of a common guideline may specify market rates for various actions (such as the storage of a given amount of information). The value that becomes a payment may, for example, be a value that is a public key for which the service bounty hunter knows the corresponding secret key. To spend a payment corresponding to a recorded, valid, and valuable assertion, the service bounty hunter may need to prove knowledge of this secret key. This can be done by generating a digital signature indicating the portion of the value associated with the public key to be transferred to a recipient of the payment.

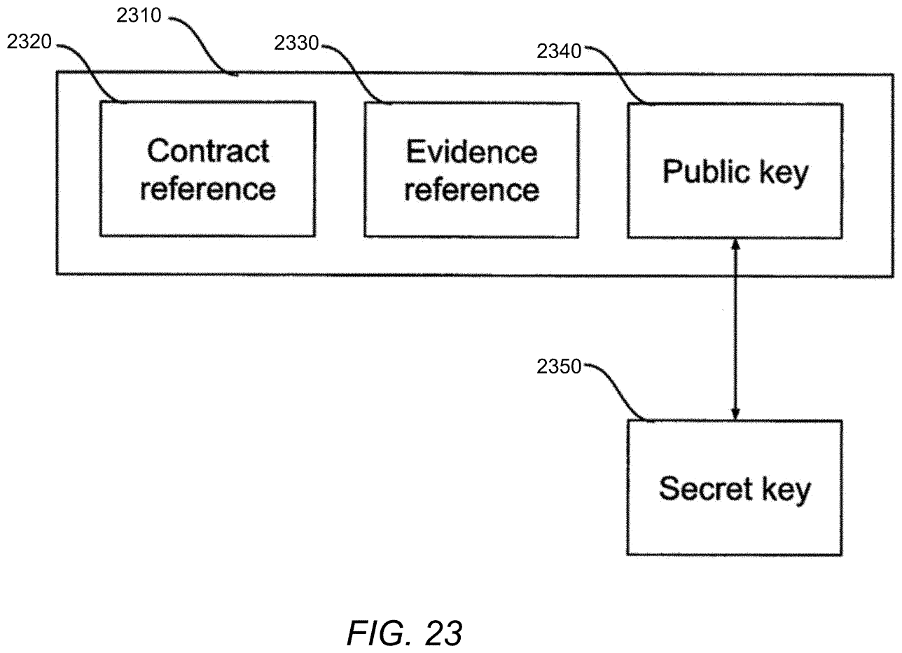

An example assertion in accordance with many embodiments of the invention is illustrated in FIG. 23. An assertion 2310 may include, but is not limited to, a reference 2320 to a contract, an evidence reference 2330 related to evidence, and a public key 2340 belonging to a service bounty hunter. The public key 2340 may also have a corresponding to secret key 2350. When a quorum of miners has determined that an assertion 2310 is valid and valuable, and a winning miner has included the ledger entry including assertion 2310 when computing the challenge used for mining, then assertion 2310 may become a coin. A coin may be a financial entity that is described further below. The value of a given coin may be determined by the corresponding contract. The value of the coin may also be determined by commonly agreed information. To spend the coin corresponding to an assertion 2310, the service bounty hunter can generate a digital signature on a message using the secret key 2350; this payment can then be verified using the public key 2340.

The value of closing the ledger may be very different from the value of bounty hunting, and the two need not be functionally related. For example, the value of a coin created by mining may be determined by a market in which such coins are bought and sold in the marketplace. Meanwhile, the coin corresponding to successful bounty hunting may be specified by a contract, one or more policies, and/or some quorum agreement related to the value of various types of services.

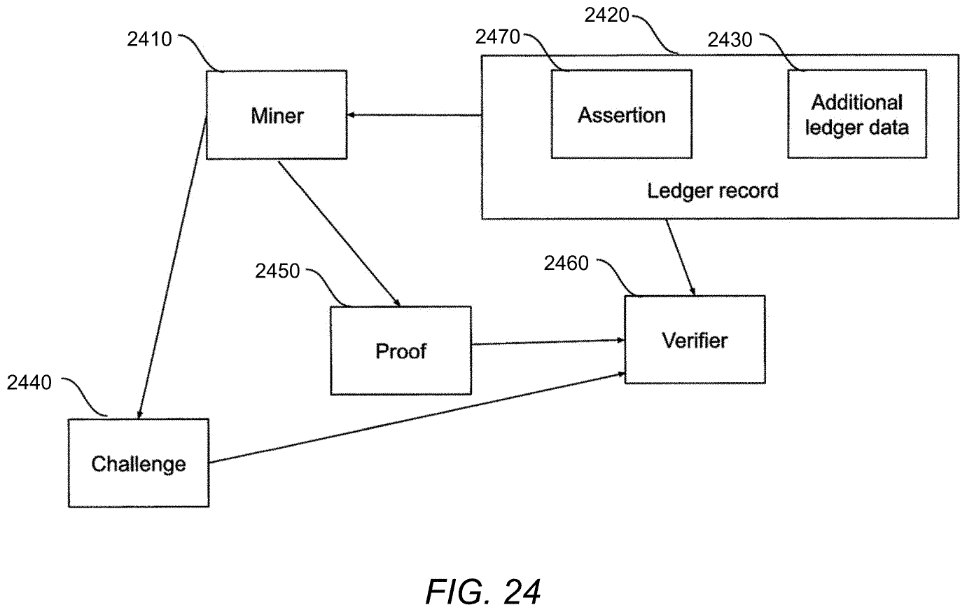

Determining the payment of many contracts may depend on assessing the validity of any associated assertions. An illustration of an assertion posted on a ledger record, in accordance with some embodiments of the invention, is reflected in FIG. 24. Ledger records 2420 can include an assertion 2470 submitted by a service bounty hunter, as well as optional additional ledger data 2430.

Processes to produce a coin from an assertion in accordance with a number of embodiments of the invention may depend on ledger records. One of the miners 2410 that accesses a ledger record 2420 with an assertion 2470 may generate a challenge 2440. If an assertion has been determined by the miner 2410 not to be valid and/or valuable, then the miner 2410 may exclude the assertion 2470 from the ledger record 2420 before computing the challenge 2440.

From the challenge 2440, a proof may be generated 2450. When the generated challenge 2440 and proof 2450 are published, verifiers 2460 may assess the proof's validity, and by extension, the validity of the assertion (as vouched for by the miner).

Upon checking the proof 2450, verifiers 2460 can determine whether the proof 2450 may be correct by accessing the ledger record 2420, challenge 2440 and/or data related to proof 2450. A verifier 2460 may be another miner. If a verifier 2460 disagrees with the assertion in a ledger record 2420, then it can generate a different challenge than challenge 2440 published by the miner. Accordingly, the verifier 2460 may disagree that the proof 2450 is valid relative to the challenge 2440 and ledger record 2420.

If a quorum of verifiers determines that the proof 2450 is correct, then the corresponding assertion 2470 can become a coin. In many embodiments, portions of the proof 2450 and assertion 2470 can also correspond to multiple coins.

The coin corresponding to the proof 2450 can be spent by the miner 2410, who knows secret key corresponding to the public key part of the coin. The spending may be performed by signing a message using the secret key, where the message states the amount to be transferred and to whom. The recipient of a payment may be indicated by a public key associated with the recipient.

The value of a coin created by successful bounty hunting may also be a function of the value of the coin created by successful mining. For example, the value of the coin created by successful bounty hunting may be 1/100th of the coin created by successful mining.

A contracted service provider may be paid on a regular basis. For example, in some embodiments, a contract may have a payment schedule of once a year. A portion of the contract can specify the conditions of the service, including what service is to be provided; an amount to be paid; and when payment can be collected. Another portion may include a public key. In a number of embodiments, a payment of the service provider is completed by the conditions being satisfied. Thus, the contract, or a portion thereof, becomes a coin. The value of this coin is specified by the contract, or by an external resource that is commonly agreed on. An example of an external resource is a collection of service providers that establish a price and notify the miners or other parties.

If any successful bounties have been claimed against a contract, then the value of the coin associated with the contract for the associated time period (such as calendar year) may be reduced. The reduction may be the amount which was paid in the bounty, but it may also exceed this value. For example, if a non-contracted service provider was identified as providing the service, while the contracted service provider was found not to provide the service, then an additional amount may be deducted, which can be claimed by the non-contracted service provider.

Service bounty hunters in accordance with several embodiments of the invention may indicate the identity of the non-contracted service provider by including the public key of the non-contracted service provider in the assertion. This public key, accordingly, can get assigned a value that is determined by one or more policies, a contract, and/or by consensus. As mentioned elsewhere, the value can be spent by proving knowledge of the corresponding secret key. This can be done, for example, by generating a digital signature on a message indicating the identity of the recipient and the amount or portion to be transferred.

In many embodiments, contracted service providers can turn contracts (e.g., service provider agreements) into coins by claiming (or asserting) that the service has been provided. When this statement is not true, NFT platforms in accordance with a variety of embodiments of the invention can allow bounty hunters to make counter-claims against that claim by indicating evidence showing a valid and valuable assertion related to the contract for the corresponding time period. When the evidence is validated, a payment can be made to the bounty hunter and a penalty assessed to the lying service provider; this is handled analogously to how the assertions are handled. In numerous embodiments, service providers with one or more successful assertions against it can still be paid a portion of the contracted amount by making a claim including a truthful indication of what assertions were successfully made corresponding to the contract for the time period of relevance. When some assertions are successfully made, a portion of the payment may be made to the service provider (e.g., as determined by a policy). When the claim of partial performance is truthful, bounty hunters in accordance with numerous embodiments of the invention cannot successfully file a complaint against the service provider. By providing flexibility in the assertion mechanism, contracts can be enforced while also enforcing assertions and claims and their associated truthfulness. The truthfulness of any such claim or assertion can be determined in a distributed manner, in a quorum action, e.g., by the miners that close ledgers. One skilled in the art will recognize that similar systems and methods for crypto payment can be used in a variety of applications, including (but not limited to) those which are not based on mining, without departing from this invention. For example, determinations of truthfulness can be made by a centralized entity or by a collection of parties that perform a proof of stake.

In a number of embodiments, service providers can provide bullet-proof hosting, wherein one or more service providers are contracted to provide the services. Failure to provide services in accordance with a number of embodiments of the invention can be penalized by withholding payment, as described above.

In a number of embodiments, bounty hunters can receive payment for detecting and reporting illegal content (e.g., child pornography). In a variety of embodiments, the size of the payment can be determined and/or influenced by one or more policies specified in an agreement associated with the automated conditional payment and/or based on common guidelines. The value of the coin created by successful illegal content bounty hunting in accordance with numerous embodiments of the invention may also be a function of the remaining value of the coin between the asset owner and the service provider. As illegal content is located, it is removed, disabled, or access to it is controlled, limited, surveilled, or otherwise managed.

In a number of embodiments, requested services can include a policy that is used to determine the legality of an action. For example, if a service provider agrees to host some encrypted data, not knowing what the plaintext is, and it is later found that the plaintext data was illegal, then the service provider may be held harmless for not hosting the encrypted data. When failure to provide a service is due to the illegality of an action, NFT platforms in accordance with some embodiments of the invention may still provide payment to the service provider. In numerous embodiments, decisions on whether to pay the service provider may depend on a policy that determines what is illegal and/or whether the service provider should still be held liable. For example, a service provider that hosts child pornography, and is commonly assumed to know that this took place, should not be paid. In certain embodiments, miners can make a determination by quorum action of whether the service provider should be paid or not, based on evaluation of the policy and available evidence, where some such evidence may be provided by bounty hunters in the same manner as described herein. In contrast, service providers that are found to not have known that the data was illegal, and are determined to have made a best effort to determine, can still be paid. In either case, the service provider would be encouraged to not host the illegal content anymore. In a number of embodiments, if it is found that service providers still host data that they should not (e.g., previous storage of the data has been found to be illegal), then such service providers can be penalized by withholding yet other payments or portions thereof, such payments not related to the illegal data, but to the provision of other services. NFT platforms in accordance with a number of embodiments of the invention can enforce such policies using bounty hunters, quorums of miners, and other verification methods. This way, any form of societal norm can be enforced, as long as it can be publicly verified with a very large probability. Processes in accordance with numerous embodiments of the invention can be used, not only for enforcement of contracts, but also for enforcement of laws, using financial incentives and disincentives.

In numerous embodiments, data commitments can be used to associated and/or verify the provision of services associated with a particular set of data. It may be beneficial to associate content, such as the data of an NFT, with a commitment to the same, and to a contract (e.g., with an NFT purchase description). An example of a data commitment in this context is a one-way hash of the data including an NFT asset. If this is included in or referenced in a purchase transaction, in a hosting contract, or both, then it can be indisputable whether a tentative stored content is the same as the data desired to be stored. This follows from the collision-freeness of the commitment scheme, making it computationally infeasible to create a second content and claim that it matches a first content when the contents are not in fact the same. In several embodiments, the commitment, such as a SHA-256 of content, can be included in an agreement. For example, in a hosting agreement, so data commitments can be used to objectively assess whether a given content matches the content to be stored under the contract. Similarly, data commitments can enable a non-contracted service provider to prove that a given stored content is a particular content. Furthermore, data commitments can enable bounty hunters to determine, with certainty, whether a given stored content matches or does not match a given NFT. Data commitment techniques in accordance with a variety of embodiments of the invention can also be applied to items that are not NFTs (e.g., those which can be expressed as data streams that do not change over time, where changes can be undone, where it is possible to determine whether a given content is an acceptable version of content that has been committed to, and/or where the function of determining whether it is acceptable may involve evaluating one or more policies on the data). For example, committed data may be in part an executable program and in part its inputs, and a match may be performed with respect to the entire executable part, and only a portion of the input.

NFT platforms in accordance with some embodiments of the invention can also be used to create new instruments, such as an annuity coin. An annuity coin can be considered an automated conditional payment coin that is conditional on the passage of time. For example, a first party creates an annuity coin by creating a contract that specifies at least one recipient and at least one term of how funds can be received by this at least one recipient. The user then creates an annuity coin by transferring value to this contract. The contract could identify one or more recipients using one or more public keys. The one or more recipients would be able to store the annuity coin, but would not be able to spend any portion of it until the terms permit this. For example, one example term may specify that an amount of $1000 can be received at the first day of each month until the remaining value is exhausted, at which time the remaining value is received. As another example term, a portion of the full value may be received on an annual basis until the remaining value falls below a certain threshold value, at which time this is received. In certain embodiments, terms may include other conditions either in place of or in addition to time. For example, the trigger for receiving value may be tied to the occurrence of an event that can be publicly verified to have taken place, or both; for example, after the stock market has reached a specified value, a recipient has received a PhD, or the payer has died. The latter can be determined in an objective manner by the absence of a signal indicating liveness, such as the absence for at least six months of a new tweet associated from a specified account. When a condition associated with the contract (or agreement) associated with the annuity coin is satisfied, then the holder of the secret key associated with the contract specified public key may be able to spend the received amount by generating a proof, such as a digital signature, that transfers value to a recipient party.

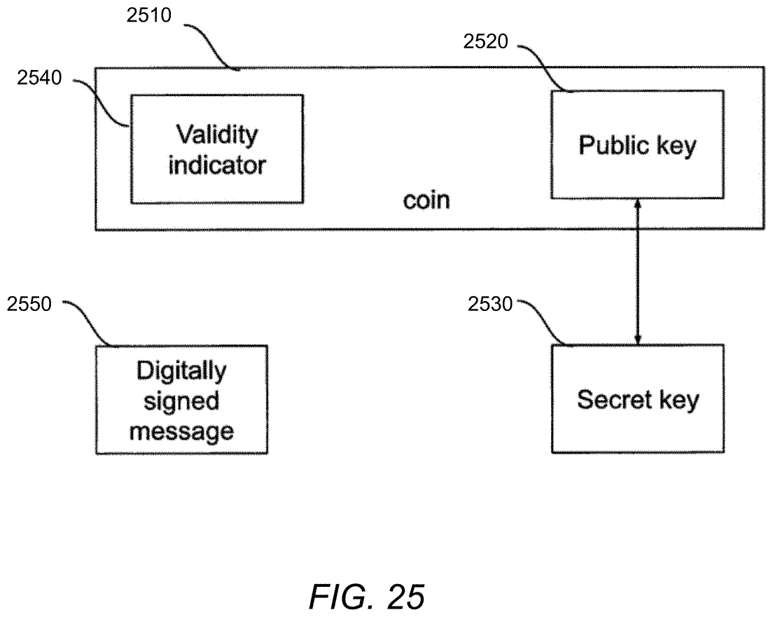

A coin configuration, in accordance with many embodiments of the invention, is illustrated in FIG. 25. The coin 2510 may include a validity indicator 2540 and public key 2520, where the public key corresponds to a secret key 2530. To spend at least a portion of the coin 2510, the owner of the coin 2510 can generate a digitally signed message 2550 by generating a digital signature on a recipient public key using secret key 2530.

To verify the validity of the coin 2510, a verifier can evaluate the coin's validity indicator 2540. A party may accept the coin 2510 if the validity indicator 2540 can be verified to be correct. A validity indicator 2540 can include a variety of information of different formats. One type of format of validity indicator 2540 can be a challenge and a proof, which corresponds to the coin 2510 being a mined coin. Such a validity indicator 2540 can be verified by determining that the proof is a valid proof relative to challenge.

Another type of validity indicator may be a contract reference and an evidence reference, which can be verified in at least two different ways. The first may be, by evaluating that the evidence reference is correct with respect to the contract reference. The second may be by determining that assertion was indicated to be a valid assertion of ledger record, and that ledger record has been accepted by a quorum of miners as legitimate. Evidence of legitimacy may be another ledger record including additional ledger data.

A third type of the coin may be a contract, where the validity indicator can include, but is not limited to, a service description, payment policy, optional service provider data, coin reference and payer signature. Additionally, the payer signature can correspond to the coin reference, wherein the coin reference and payer signature are part of a digitally signed message.

A fourth type of coin may be produced as a payer generates a digitally signed message 2550 on a public key, for a coin of a valid format. The public key may also be included and/or referenced in the validity indicator 2540. Thus, coins can be spent at least in part, and the recipient of such a coin that is spent in part can spend such funds by generating new digitally signed messages 2550 using the secret key corresponding to the public key being signed in the coin.

Bounty hunters in accordance with many embodiments of the invention may provide statements (or assertions) regarding the performance of a service. In a number of embodiments, one or more bounty hunters generate assertions related to levels of quality of service provision, wherein each assertion is associated with a reputation score of the bounty hunter that generated the assertion. Miners can determine the validity of an assertion based on various factors, including (but not limited to) verifying the quality of service level of the service provider at the time of the validation; assessing the number of assertions related to the same service provider; and/or assessing the reputation of the bounty hunters that generated the assertions. Reputation levels in accordance with some embodiments of the invention correspond to the portion of previous assertions that have been determined to be valid, whether they were also determined to be valuable or not. If there are multiple bounty hunters filing assertions related to the same contract, then in a number of embodiments, a portion of these are provided with a reward in the form of a payment. In certain embodiments, determinations of which bounty hunters are selected to receive payment can be made based on various factors, including (but not limited to) which ones were first to generate the assertion; which ones generated an assertion that described the most accurately the quality of service level observed by the miner and the verifiers; and/or a function of the bit sequences that include the assertions. For example, if there are multiple competing bounty hunters with assertions related to the same contract and only one should be rewarded, then the miner may select the one for which the corresponding assertion, when hashed and considered as a binary number, is the smallest distance from the value computed from a publicly observable quantity, such as a hash of the contents of the ledger record appended to the public key of the miner. Here, distance can be interpreted by comparing the two binary numbers. This way, one or more valid assertions related to one and the same contract can be selected and included in the ledger record, and other assertions are disregarded and not included in the ledger entry, or disregarded for purposes of the award but still included in the ledger entry. Since the selection can be publicly verified, all verifiers can determine what assertions were selected as valuable.

Bounty hunters may be audited by verifiers and/or other bounty hunters. NFT platforms in accordance with certain embodiments of the invention may provide reputation mechanisms that provide each bounty hunter with a reputation score. Reputation scores may increase as a bounty hunter successfully submits more assertions. If a bounty hunter ever is shown to have provided a false assertion, that may severely affect their reputation score, e.g., cutting it in half. Bounty hunters that provide evidence of cheating by another bounty hunter, conversely, may benefit in terms of reputation from providing such evidence, and the gain may be greater for a cheating bounty hunter with a high reputation than one with a low reputation, thereby creating incentive to audit high-reputation bounty hunters. In a variety of embodiments, the payment a bounty hunter receives for successfully submitting an assertion may depend on its reputation, e.g., a greater profit for high-reputation bounty hunters. This can further incentivize bounty hunters to be honest, as it improves the future profits. It also causes bounty hunters to collaborate and pool information, and to maintain high standards within the group, using a group identity to submit assertions. This also helps aggregate a smaller number of highly trustworthy bounty hunters, which helps reduce the effort to verify assertions, which in turn is an efficiency improvement for the collective of participants. In other words, this creates an efficient marketplace of honest participants. Reputation mechanisms in accordance with some embodiments of the invention can be leveraged for other purposes as well, e.g., product reviews and feedback about what NFT resources are highly desirable. This can help users select what NFT and other digital data to seek out and consume.

In a number of embodiments, bounty hunters can provide the service of bounty hunting relative to one or more other service provision contracts, or relative to one or more service providers. For example, a bounty hunter may be under contract from entity A to verify whether entity B provides services to entity C according to a pre-specified quality level of service. This is yet another example of a service (in this case bounty hunting) that can be provided to a payer.

In some embodiments, services can also be provided to parties that are not payers, but for which there still is a contractual relationship. For example, a telecommunication provider may act as the recipient of a service that involves the policing of other services offered over its network, where a third party acts as a bounty hunter that attempts to determine whether there is abuse on the network. This may be a service the bounty hunter performs without receiving payment, but instead, in response to legislation, in response to being allowed the use of the telecommunication services, or as a selfless act, such as what a consumer representative may perform.

In a number of embodiments, contracts originating from an asset creator may be issued in the form of a perpetual auction where the service providers bid to win the perpetual bullet-proof hosting service until another bidder comes in with a better offer—even if the bid is many years later. For example, a first service provider to offer a reasonable perpetual service wins the business initially. The creator of an audio track suitable for website background music creates a perpetual auction whereby a first hosting service provider agrees to host the music for a $100 annuity that pays the service provider $1 in the first year and 1% less every year thereafter. The audio track creator funds the contract at time zero. At any time in the future, another provider may underbid the current hosting service. In a variety of embodiments, the current hosting service may have the option to either shift the asset access to a lower bidding service provider or to match the proposed bid. In this example, whether the first service provider matches the bid or shifts the asset access, the creator of the audio track may receive a partial refund that reflects the cost reduction's impact on the original annuity funding. The ability to recoup a portion of the initial $100 funding is enhanced by the competitive incentives to keep the hosting price low, especially if future hosting costs turn out to be lower than expected relative to the currency's inflationary or deflationary movements.

In a number of embodiments, resources, such as NFTs, can be associated with an agent that acts on behalf of the NFT owner, and can perform the task of the payer in that it identifies future service providers and executes a contract, e.g., a smart contract, with one or more of these. Agents can remain active and also perform other tasks, such as that of a bounty hunter, identifying and reporting of service discontinuations. This can be done both for services related directly to the NFT associated with the agent itself, and/or relative to other NFTs associated with the same owner (or collective of collaborating owners). In several embodiments, two or more agents can collaborate to exchange information and watch over each other, in terms of service provision, filing assertions whenever the other NFT (and associated agent) is not being given the proper level of quality of service.

In a variety of embodiments, NFTs for automated conditional payments can share the resources it is being provided (e.g., computational resources and bandwidth) with other NFTs. This way, NFTs in accordance with certain embodiments of the invention, using an associated agent, can act as a virtual service provider, using portions of the services provided to it by its (physical or virtual) service provider to provide services to other users and NFTs. Thus, service providers can be either physical or virtual, wherein a virtual service provider can share resources that it is being provided by a physical service provider by performing a task on behalf of another entity.

In a number of embodiments, composite NFTs are generated from two or more NFTs. Composite NFTs in accordance with a variety of embodiments of the invention may be based on optional rights to combine that may be controlled by owners or originators of the resources associated with the NFTs. In several embodiments, rights to the NFTs can be expressed in the form of policies that are verified using an access control determination as disclosed herein and/or using a digital rights management (DRM) implementation residing on an approved client device. Composite NFTs in accordance with some embodiments of the invention may include components from multiple NFTs. For example, a composite NFT may include a first character from a first NFT and text from a second NFT to generate an audiovisual aspect of the first character from the first NFT speaking the text of the second NFT. In various embodiments, a second composite NFT may include a second character from a third NFT and the same text from the second NFT to generate an audiovisual aspect of the second character speaking the same text of the second NFT. In certain embodiments, the right to combine NFTs (e.g., from the creators/owners of the component NFTs to be combined) can be determined by policies associated with the NFTs. Policies in accordance with some embodiments of the invention may include a rule that requires a token for activation (e.g., tokens as described above in the context of access control mechanisms).

Applications and methods in accordance with various embodiments of the invention are not limited to use within NFT platforms. Accordingly, it should be appreciated that system maintenance mechanisms described herein can also be implemented outside the context of an NFT platform configuration unrelated to the storage of fungible tokens and/or NFTs. Moreover, any of the reporting mechanisms described herein with reference to FIGS. 18-25 can be utilized within any of the configurations discussed above. Various systems and methods for implementing NFT platforms and applications in accordance with numerous embodiments of the invention are discussed further below.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A system for ensuring service performance, the system comprising:
a paying module that generates an agreement with a service provider, the agreement comprising terms of the performance of service; and
at least one bounty hunting module, wherein the at least one bounty hunting module confirms the service performed by the service provider by:
reviewing the agreement;
obtaining publicly verifiable evidence related to the performance of service;
generating an assertion comprising the publicly verifiable evidence and a reference to a public key;
posting the assertion to an immutable ledger entry; and
obtaining payment based on validity of the assertion.

2. The system of claim 1, wherein posting the assertion to an immutable ledger entry comprises:
posting a commitment to the assertion to a first immutable ledger entry, wherein the commitment includes a hash of the publicly verifiable evidence, the public key, and a random string; and
posting a decommitment to the assertion to a second immutable ledger entry, wherein the decommitment includes the publicly verifiable evidence, the public key, and the random string;
wherein the second immutable ledger entry is generated subsequently to the first immutable ledger entry.

3. The system of claim 2, wherein the hash utilizes a SHA-256 hash function.

4. The system of claim 1, wherein posting the assertion to an immutable ledger entry comprises using a verifiable delay function on the assertion,
wherein the verifiable delay function utilizes a Proof of Work mechanism.

5. The system of claim 1, wherein the system further comprises one or more miners,
wherein at least one miner assesses the validity of the assertion, wherein assessing the validity of the assertion comprises:
accessing the immutable ledger entry;
reviewing the assertion comprising publicly verifiable evidence related to the performance of the service;
evaluating the validity of the publicly verifiable evidence, wherein publicly verifiable evidence is data, relevant to the performance of the service, that is gathered through communication over a network; and
when the publicly verifiable evidence is evaluated to be true:
including the assertion in a block;
generating a challenge based, at least in part, on the block;
generating a proof based, at least in part, on the challenge; and
publishing the challenge and the proof on the immutable ledger entry.

6. The system of claim 5,
wherein a quorum of verifiers further assesses the validity of the assertion, wherein each verifier assesses the validity of the assertion by:
accessing the block, the challenge, and the proof through the immutable ledger entry;
reviewing the assertion comprising publicly verifiable evidence related to the performance of the service;
evaluating the validity of the publicly verifiable evidence in the assertion;
when the publicly verifiable evidence is evaluated to be false, generating a new challenge based on a new immutable ledger entry, wherein the new immutable ledger entry omits the assertion; and
when the publicly verifiable evidence is evaluated to be true, transmitting assent to including the block on a ledger.

7. The system of claim 1, wherein:
the service provider agrees to provide access control to NFTs for the paying module,
access control comprises facilitation of NFT access by members of the public, and
different token classifications indicate different rights of access to the service provider.

8. The system of claim 7, wherein bounty hunting modules may collect publicly verifiable evidence of failure to perform the service by:
attempting to obtain access to the NFTs without meeting particular rights of access;
being allowed access by the service provider; and
noting the failure to facilitate token access as the publicly verifiable evidence of failure to perform the service.

9. The system of claim 1, wherein:
the agreement is with a virtual service provider and a second service provider is a physical service provider, and
the physical service provider provides resources to the virtual service provider, and the virtual service provider shares the resources provided by the virtual service provider by performing a hosting task.

10. The system of claim 9, wherein the virtual service provider is a non-fungible token (NFT).

11. The system of claim 1, wherein obtaining payment comprises:
conveying a message to the paying module,
wherein the message comprises a coin reference, an amount indicator, and the public key,
wherein the reference indicates a financial entity from which funds are to be transferred,
wherein the amount indicator indicates the amount of and type of currency associated with the transfer; and
wherein the public key is associated with a recipient of the funds;
receiving the message after the message has been digitally signed by the paying module,
wherein the message is digitally signed using a secret key corresponding to the public key, and
wherein the digitally signed message indicates value associated with the transfer.

12. The system of claim 1, wherein:
each bounty hunting module is associated with a reputation score,
invalid assertions decrease the reputation score and valid assertions increase the reputation score, and
payment obtained by a bounty hunting module is positively correlated with the bounty hunting module's reputation score.

13. A device configured to interact with a composite NFT, the device comprising:
a network interface;
memory; and
a processor, the processor configured to:
access bytecode stored within an immutable ledger, where the bytecode encodes a composite non-fungible token (NFT) and includes references to bytecode stored within the immutable ledger encoding two or more additional NFTs; and
execute the bytecode encoding the composite NFT within a virtual machine, where:
execution of the bytecode selects a content component from each of the two or more additional NFTs; and
the content components from each of the two or more additional NFTs are accessed by causing execution of the bytecode stored within the immutable ledger that encodes the two or more additional NFTs; and provide access to the selected content components for display;
wherein each of the selected content components is selected from a group consisting of audio components, visual components, and audiovisual components.

14. A device configured to perform transactions involving annuity coins, the device comprising:
a network interface;
memory; and
a processor, the processor configured to:
receive a digitally signed message, where the digitally signed message is signed using a secret key associated with a public key that identifies an account of an intended recipient of funds;
access bytecode stored within an immutable ledger, where the bytecode encodes an annuity coin that includes:
the public key associated with the secret key; and
a validity indicator; and
execute the bytecode encoding the annuity coin within a virtual machine, where execution of the bytecode:
verifies the validity indicator; and
broadcasts a transaction transferring at least some of the funds to the account of the intended recipient of the funds identified by the public key.

15. The device of claim 14, wherein execution of the bytecode determines a trigger for transferring funds at least some of the funds to the account of the intended recipient of the funds identified by the public key based upon verifying an occurrence of a publicly verifiable event.

16. The device of any of claim 14 or 15, wherein:
the validity indicator is a challenge and a proof corresponding to the annuity coin; and
the validity indicator is valid when the proof is a valid solution to the challenge.

17. The device of any of claims claim 14 or 15, wherein the validity indicator comprises:
a reference to a contract between a payer and the recipient of the funds; and
a reference to evidence of contract performance.

18. The device of any of claim 14 or 15, wherein:
the validity indicator comprises a digitally signed message from a paying module; and
a reference to another coin.

19. A machine readable medium containing bytecode stored within an immutable ledger, where the bytecode encodes an annuity coin comprising:
a validity indicator, wherein the validity indicator confirms existence of funds backing the annuity coin; and
a public key that identifies an account of an intended recipient of the funds; and
execution of the bytecode causes:
verification of a digitally signed message, where the digitally signed message is signed using a secret key associated with the public key; and
broadcast of a transaction transferring at least some of the funds to the account of the intended recipient of the funds identified by the public key.

20. The machine readable medium of claim 19, wherein a trigger for transferring value to the annuity coin is tied to an occurrence of a publicly verifiable event.

21. The machine readable medium of any of claim 19 or 20, wherein:
the validity indicator is a challenge and a proof corresponding to the annuity coin; and
the validity indicator is valid when the proof is a valid solution to the challenge.

22. The machine readable medium of any of claims claim 19 or 20, wherein the validity indicator comprises:
a reference to a contract between a payer and the recipient of the funds; and
a reference to evidence of contract performance.

23. The machine readable medium of any of claim 19 or 20, wherein:
the validity indicator comprises a digitally signed message from a paying module; and
a reference to another coin.
